(19) United States
(12) Patent Application Publication
(10) Pub. No.: US 2016/0366183 A1
(43) Pub. Date: Dec. 15, 2016

(54) System, Apparatus And Method For Access Control List Processing In A Constrained Environment

(71) Applicants: Ned M. Smith, Beaverton, OR (US); Mats G. Agerstam, Portland, OR (US); Nathan Heldt-Sheller, Portland, OR (US)

(72) Inventors: Ned M. Smith, Beaverton, OR (US); Mats G. Agerstam, Portland, OR (US); Nathan Heldt-Sheller, Portland, OR (US)

(21) Appl. No.: 15/168,609

(22) Filed: May 31, 2016

Related U.S. Application Data
(63) Continuation-in-part of application No. 14/856,857, filed on Sep. 17, 2015.
(60) Provisional application No. 62/172,906, filed on Jun. 9, 2015.

(51) Int. Cl. H04L 29/06

(52) U.S. Cl. CPC H04L 63/20; H04L 63/101; H04L 63/06; H04L 63/0823

(57) ABSTRACT

In one embodiment, a system includes: a credential management server to provide credentials to a plurality of computing devices and a plurality of resource servers; a rights management server to grant capability rights to the plurality of computing devices; and an access management server to assign access control policies for a plurality of resources to be protected by the plurality of resource servers. A first resource server may receive a first access request for access to a first resource from a first computing device and send the first access request to the access management server for determination of whether to grant a permission for the access to the first resource. Other embodiments are described and claimed.

This application claims priority to U.S. Provisional Patent Application No. 62/172,906, filed on Jun. 9, 2015, in the names of Ned M. Smith, Mats G. Agerstam and Nathan Heldt-Sheller, entitled SYSTEM, APPARATUS AND METHOD FOR ACCESS CONTROL LIST PROCESSING IN A CONSTRAINED ENVIRONMENT, and is a continuation-in-part of U.S. patent application Ser. No. 14/856,857, filed Sep. 17, 2015, the disclosures of both of which are hereby incorporated by reference.

### BACKGROUND

Internet of Things (IoT) networks, unlike enterprise and cloud networks, are expected to function even when central servers fail or are not available. IoT networks may be designed to be survivable under adverse conditions; for example, while a building may be burning down, partially destroyed due to acts of nature or due to physical world mishap. Damage to one part of a building, resulting in damage to the IoT network there, should not result in failure of the IoT network in an untouched part of the building. Security mechanisms are among the features to retain operational integrity during survivability situations.

Design considerations for survivable and secure IoT networks include reliable application of access control policies. Popular approaches to access control in the Internet typically provide for central authentication, authorization and key management servers. Access decision making is shifted from an endpoint device to this central service. In other words, the policy enforcement point (PEP) is separated from the policy decision point (PDP). Nevertheless, IoT networks are anticipated to continue being constructed from highly constrained devices that often lack the sophistication to implement complex policy decision logic.

### BRIEF DESCRIPTION OF THE DRAWINGS

FIG. 1 is a block diagram of a system in accordance with an embodiment.

FIG. 2 is a block diagram of an implementation of local ACL in accordance with an embodiment.

FIG. 3 is a block diagram of an implementation of local ACL with remote decision making in accordance with an embodiment.

FIG. 4 is a block diagram of an implementation of ACL redirection in accordance with an embodiment.

FIG. 5 is a flow diagram of a resource optimization method in accordance with an embodiment.

FIG. 6 is a block diagram of an example system with which embodiments can be used.

FIG. 7 is a block diagram of a system in accordance with another embodiment of the present invention.

FIG. 8 is a block diagram of a wearable module in accordance with another embodiment.

FIG. 9 is a block diagram illustrating example ACE and capability records showing fields for matching client (subject) to resource in accordance with an embodiment.

FIG. 10 is a block diagram of a system in accordance with another embodiment of the present invention.

FIG. 11 is a block diagram of a computer network in accordance with an embodiment of the present invention.

FIGS. A-T are diagrams of interactions in accordance with various embodiments.

### DETAILED DESCRIPTION

In various embodiments, a system of access control policies are simplified for IoT class devices. Still further, varying degrees of distribution and coalescence are provided so that as much of the access control decision making can be applied as close to the device as possible (resources permitting) if not directly by the device itself.

Embodiments define access policies using the same nouns and verbs (e.g., resources and constrained application protocol (CoAP) commands) used to describe IoT device interactions so that a mapping or translation to an access control grammar such as extensible access control markup language (XACML), open authorization (OAuth), security assertion markup language (SAML), etc., is avoided. Processing resource access requests is applied by the endpoint device, also known as the resource server. Access control policy lists (ACL) resources capture the device-to-resource interaction semantic and apply an allow/deny policy expressed in terms of the possible ways in which the resource may be manipulated (e.g., CRUDN, Create, Read, Update, Delete and Notify). Other actions are envisioned as IoT device interaction semantics evolve.

Note that a representation of the ACL may be considered to be an IoT resource as well. This abstraction allows security operations to be performed using the same IoT messaging mechanisms that are used to interact with application resources. In this way, greater interoperability and more effective use of system resources such as memory and storage are achieved.

IoT devices are often resource constrained, therefore a tradeoff is made regarding how much of the device resources are used to achieve resilience properties vs. scalability properties. For example, a locally stored ACL enables the device to process access control requests even when connectivity to the rest of network is blocked or when the authorization server(s) are down. However, since devices are resource limited, only a small number of ACLs can reside locally. Scalability goals may partition requestors into categories of resiliency where access by devices that may protect critical infrastructure, preserve life or protect property assets may occupy local resources. Less critical functioning devices may employ access control mechanisms that refer the access decision to a nearby, but less resource limited IoT device. The price of scalability is the network latency and single point of failure cost of having to rely on a neighboring IoT device. Still another class of devices may rely on a central service to issue ACL policies, but these may occupy device resources temporarily. During the validity period, connection to the central facility may be severed but access control is maintained. Fully scalable solutions rely on a central service for all ACL processing and decision making. Failure in the connectivity or operation of the central policy service results in device access failure.

Using an embodiment, access control mechanisms can be tailored to IoT network topologies. For example, device resources can be partitioned according to device function as it relates to resilience objectives. In particular: ACL structures are expressed in the same format as device resources and range of function; ACL structures can be distributed across many devices; ACL structures can be self-contained such that the endpoint device can fully apply the policy (without network connectivity beyond what is available between the requesting device and the local resource server); ACL structures can be split into a local component and a remote component where the remote component identifies a helper device that is nearby according to the device topology; ACL structures can be dynamically provisioned and locally cached/stored such that the space occupied can be reused according to a heat graph of requesting devices; ACL structures can be hosted by a remote device such that all requests from a particular requestor are forwarded to a designated device; ACL structures may be hosted by a remote device such that the requesting device is redirected to the remote device to obtain a single use token granting access to a specific resource or property of the device.

In an embodiment, selection of which ACL structure to use is determined by a network setup utility that assists the network designer in determining which device functions are useful for protecting critical infrastructure, semi-critical infrastructure, preserves human life, protects health and physical property. A determination may be made regarding a weighing of resiliency vs. scalability in terms of potential impact to physical assets and cyber assets.

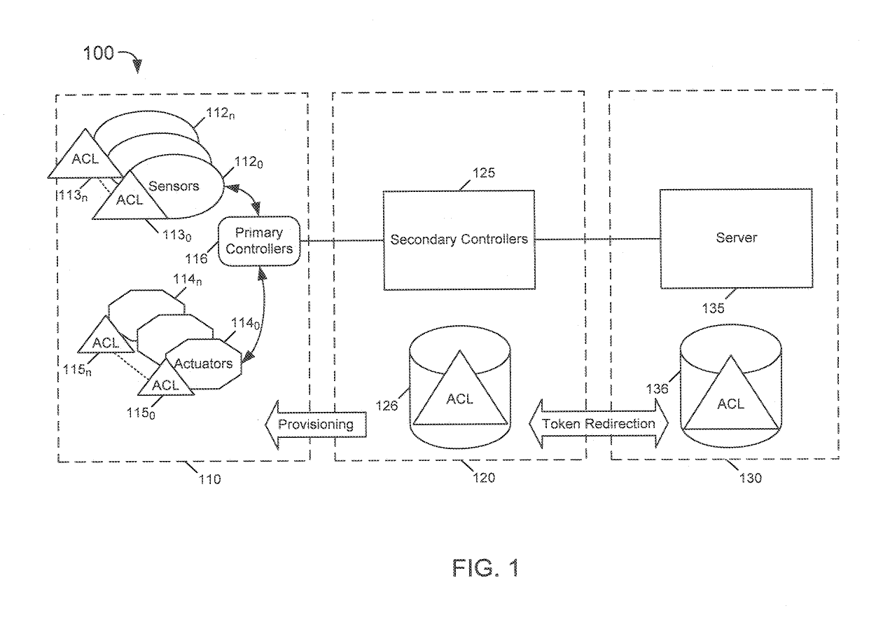

Referring now to FIG. 1, shown is a block diagram of a system in accordance with an embodiment. IoT networks are often composed of sub-networks where a portion of the network is tailored for improved resiliency, availability and safety of IoT command-and-control, while other parts of the network are optimized for improved mobility, data availability and integrity. Consequently, the access management system may be configured to accommodate these differences and design objectives.

In the illustration of FIG. 1, a system 100 includes various components that connect together in a network architecture. A first network portion 110 is configured for autonomous operation of various devices such as IoT devices within this network portion. By way of the distributed arrangement of network 100, a security policy may be distributed across a hierarchy of nodes within different network portions. In this way, high availability low latency security decisions can be made locally in first network portion 110, while greater amounts of latency and lower availability may adhere as security decisions are distributed across different portions of the network.

As further illustrated, network 100 includes a second network portion 120, which may be configured to provide semi-autonomous operation for ACL security decisions. Still further, a third network portion 130 provides for higher latency ACL security decisions to be made, such as according to a traditional client-server model, e.g., for non-safety and/or non-critical operations.

As seen, such devices may include a plurality of sensor devices 112₀-112ₙ and a plurality of actuator devices 114₀-114ₙ. In general, sensor devices 112 may be configured to sense one or more particular conditions, such as one or more environmental conditions, operating conditions associated with it or another device or so forth. In general, actuators 114 may be configured to perform some type of sensing operation and perform one or more actions based on one or more sensed parameters. To provide for autonomous operation including ACL processing, each of these devices may include an internal storage to store corresponding ACLs, shown as ACLs 113₀-113ₙ each included one of sensor devices 112, and ACLs 115₀-115ₙ each included in one of actuator devices 114. As such, sensors 112 and actuators 115 may act as their own security enforcement point by way of this included ACL.

To enable networking operations, including status, control and other operations to efficiently occur, each of sensors 112 and actuators 114 may couple to one or more primary controllers 116. In general, primary controllers 116 may provide control information to the corresponding sensor devices and actuator devices, as well as receiving reports from these devices, which may be used in making command decisions, as well as providing information to further portions of the network. In various embodiments, primary controllers 116 may be configured as a controller such as a given hardware circuit to provide control actions to sensors 112 and actuators 115. Still further, primary controllers 116 may receive updates to one or more security policies and apply such updated security policy to the sensors and/or actuators.

In the illustration of FIG. 1, second network portion 120 may be configured to include various components, including one or more secondary controllers 125. In an embodiment, such secondary controllers may be various types of computing devices, such as a smartphone, tablet computer, personal computer, server computer or so forth, gateway or other network device. Secondary controllers 125 may include or may be associated with a cache memory 126 that may store ACLs as described herein. In some cases, at least some amounts of ACLs stored in cache memory 126 may be provisioned, e.g., at least temporarily, to one or more of sensor devices 112 and/or actuators 114 within first network portion 110.

As further illustrated, requests for resource access may be either generated within secondary controllers 125 or received from devices within first network portion 110, may be routed to third network portion 130. In various embodiments, third network portion 130 may be formed of a traditional client-server model, in which one or more computing devices 135, which may be implemented as one or more server computers (as an example) are present. Central server 135 may be configured to provide a centralized security policy for network 100 and enable distribution of various security determination and enforcement actions to other devices with the network. In various embodiments, server computers 135 may provide various services, including cloud services, enterprise services, factory floor services and so forth. As seen, server computers 135 may include or otherwise be associated with a storage 136, which in one embodiment may take the form of a cache memory. In various embodiments, this database in storage 136 may be the authoritative database for all ACLs for a given network. To this end, responsive to requests for ACL processing, server computers 135 may send authentication tokens, which may be single use tokens to grant access to a requested resource of a given device, or responsive to a request for an ACL itself, an ACL can be dynamically provisioned to the device, at least temporarily.

Embodiments achieve security goals by supporting multiple approaches to ACL management and operation. IoT networks that operate autonomously have low-latency in decision making and control. Resource access decision overhead is to be minimized. Network latency is a major consideration in the overall latency budget. Embodiments may eliminate network latency by storing ACLs in sensors and actuators, closest to where the resources are hosted. For semi-autonomous operation, a secondary controller is responsible for maintaining access control policy due to expected frequency of policy update. Nevertheless, efficient low-latency operation may be implemented for a period of time or for a specific set of devices. In this scenario, a temporary ACL may be provisioned to the autonomous operating devices while tasks that are not safety critical may depend on the secondary controller being available. If unavailable, access decisions are put on hold, with minimal negative impact to safety critical functions.

For non-safety critical operation, a more traditional client-server approach may suffice where, for each access request, an authorization token may be constructed and presented to the resource host for evaluation. The resource host may validate the service issuing the token in order to determine whether the request is authorized. However, the trade-off is multiple exchanges that incur network latency at each exchange. Hence, real-time and near real-time control applications cannot be satisfied using client-server operation. However, if large number of requesting entities exists, the server can scale to satisfy the volume.

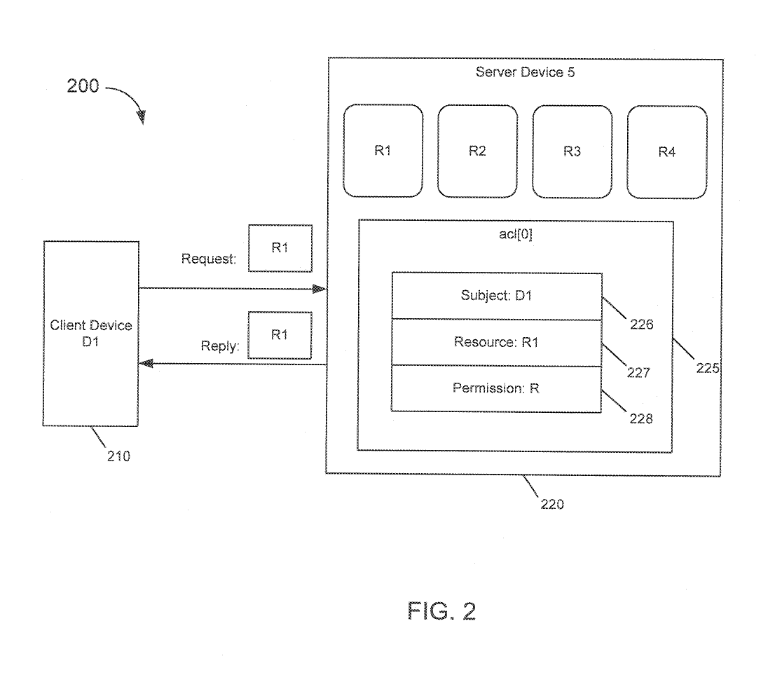

Referring now to FIGS. 2-4, shown are different techniques for evaluating ACL policies in accordance with embodiments. Note that each technique may be tuned for a particular operational optimization goal.

FIG. 2 is a block diagram of an implementation of local ACL, which may support the highest safety requirements. The device D1 (client device 210) requests access to a resource R1 hosted by the resource server (Device 5) (server device 220). The local host ACL policy allows R(ead) access to R1. This policy is evaluated without additional network latency.

As shown in FIG. 2, arrangement 200 includes a client device 210 and a server device 220. In general, client device 210 may be a requester of a resource available in server device 220. Understand that the client and server devices can take many different forms in different embodiments. However, for purposes of illustration herein, assume that client device 210 is a requesting device such as a primary or secondary controller (such as described in FIG. 1) and that server device 220 is a given IoT device such as a sensor device or an actuator device (such as described in FIG. 1), which in the case shown includes a resident ACL 225. As seen, client device 210 issues a request for access to a particular resource R1 of resources R1-R5 included in server device 220. In turn, server device 220 accesses ACL 225. As seen, ACL 225 includes various fields, including a subject field 226, a resource field 227, and a permission field 228. As seen, subject field 226 identifies a source of a request and here identifies client device 210. Resource field 227 identifies one or more resources that may be accessed by the subject, here including requested resource R1, which may be a data value stored in a particular location, such as a sensor register or other storage. In turn, permission field 228 indicates the type of permission to be granted. In this instance a read (R) permission is granted. As such, the requested resource, R1, is provided in a reply from server device 220 to client device 210. Note that permission field 228 may indicate one or more particular types of permissions to be granted. In embodiments of IoT devices, such permissions may include, in addition to CRUDN (create read update delete and notify), an additional permission to allow publication, and thus a publish permission may be provided. Note that in some cases an ACL structure can be split into a local component (ACL 225) and a remote component, where the remote component identifies a helper device that may be within a local area or otherwise associated with the device, according to a device topology. Stated another way, the local component may be used to match resources residing locally, but depends on the remote service to supply access permission guidances.

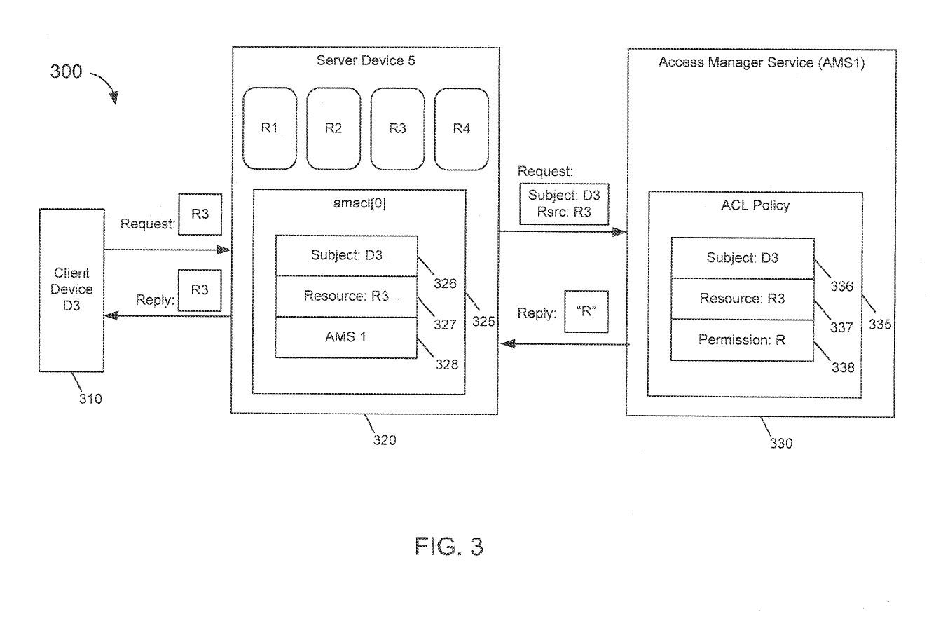

FIG. 3 is a block diagram of an implementation of local ACL with remote decision making, which may support moderately high resiliency and safety goals. In this implementation, the client device D3 (310) requests access to a resource R3 hosted by device D5 (320), but according to an ACL entry 325 (with subject, resource and distribution fields 326, 327, 328) the access decision is distributed to an Access Manager Service (AMS1) 330. The AMS has an ACL policy 335 (with subject, resource, and permission fields, 336, 337, and 338) that specifies D3's access rights. The original request is relayed to AMS1 by D5 and a response R(ead) is returned. Additional network latency is incurred for the relayed request and response, but since the AMS1 is somewhat near D5, given resiliency and safety goals can be met. Note that in various embodiments, access manager service 330 may be a secondary controller (such as shown in FIG. 1) or a traditional server (also shown in FIG. 1).

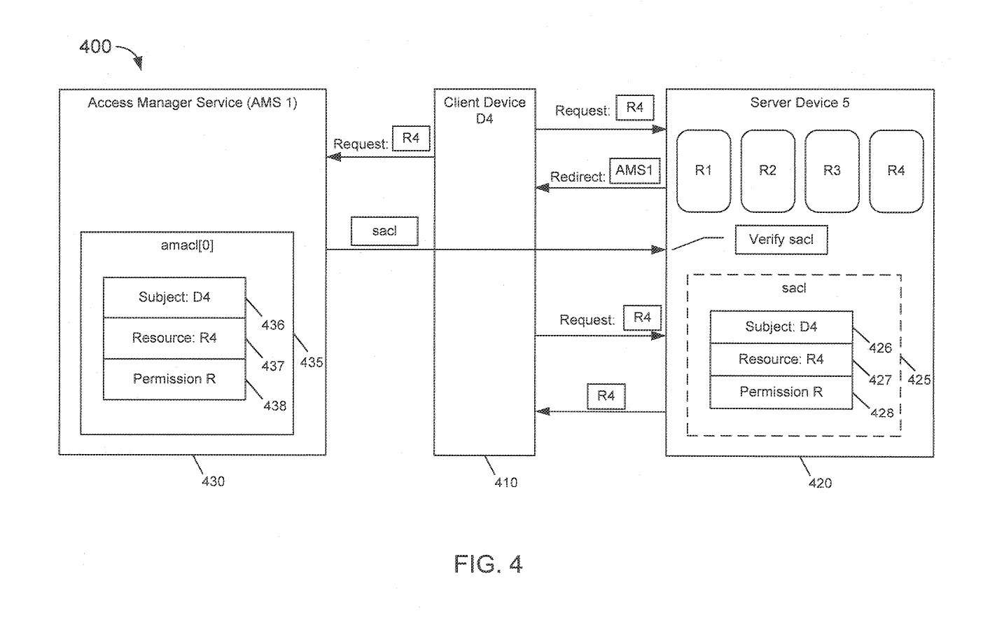

FIG. 4 is a block diagram of an implementation of ACL redirection, which may support lower expectations of resiliency. Here, a requesting device D4 (410) requests access to resource R4 hosted by D5 (420). Initially, D5 does not possess a suitable ACL policy therefore the request is denied or redirected to an Access Manager Service (AMS1) (430). This situation thus may reflect an on demand provisioning flow in which in this initial instance, server device 420 does not have a stored ACL for this subject device. D4 presents the request to the AMS that in turn issues/signs a temporal ACL that satisfies the request. D4 delivers the signed ACL to D5, and then retries the request. Thus as seen in the dashed box of FIG. 4, server device 420 receives and stores ACL 425, including constituent subject field 426, resource field 427, and permission field 428. This time the request succeeds. Subsequent requests of the same content may also succeed so long as the ACL signature is valid. Thus this cached copy 425 of the ACL may be stored, at least temporarily, in server device 420 to enable reduced latency for further requests. A variation of this technique may produce a token that contains authorization for a one-time-use permission allowing access. This may be a hybrid of FIGS. 3 and 4, and may limit access to a specific property or interface defined by the resource.

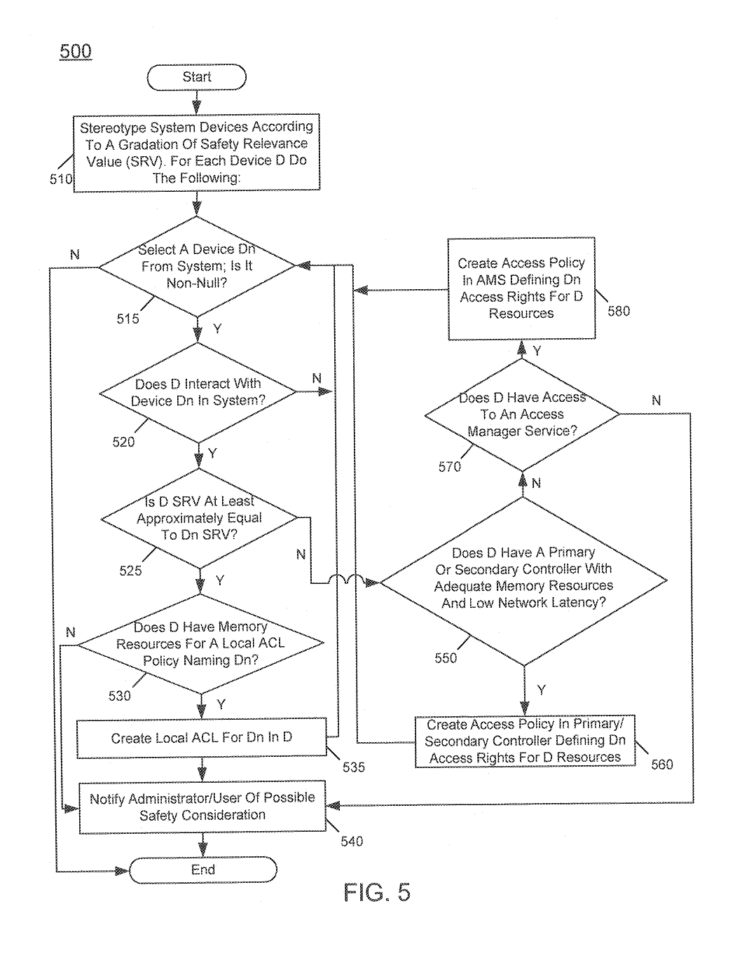

Embodiments may further determine how best to utilize constrained resources of the various sensors, actuators controllers and other servers to optimize for safety and resiliency. Referring now to FIG. 5 shown is a flow diagram of a resource optimization method in accordance with an embodiment, which may be used to ensure safe and resilient operation given limited device resources.

As one example, method 500 may be performed via a network setup utility that assists a network designer in determining which device functions can be used to protect a variety of resources. In some cases, this utility may be used during network design, as well as on-boarding of a device into a network, which may occur dynamically during system operation of an already configured network, such as a distributed network as described herein.

As seen, method 500 begins by stereotyping system devices according to a gradation of safety relevance values (SRVs) (block 510). As one example, devices may be identified as being safety relevant as to whether they perform one or more safety critical functions. For example, an emergency escape route may include emergency path lighting so that an escapee can find the escape route while crawling below a smoke line. Further, the escape route may have doors that automatically close to prevent the spread of fire. And further, doors that are activated for a fire emergency are prevented from locking closed so as not to block an escape route. A safety classification scheme further may involve assignment of a safety class rating, where a device is labeled during deployment as being L, M or Highly relevant to a safety consideration. For example, devices with a H rating may be given preferential access to encryption key storage resources, access policies and CPU scheduling on a local device to better ensure safety critical operations can complete execution with minimal external dependencies. Such designations may further involve application of a different security model, such as one that minimizes reliance on external supporting services such as an AMS.

In other cases, low, medium and high levels may be assigned to devices. In any event, after assigning relevance values to the given devices (safety and/or otherwise) within the network, an access control policy generation loop may be performed for each device D.

As seen, this loop may begin by selecting a device Dn from a list of devices of the system and determining whether this list is non-null (diamond 515). If not, control passes to diamond 520 to determine whether device D interacts with device Dn. If so, control passes to diamond 525 where it can be determined whether the safety relevance values of these two devices are at least approximately equal. Device-device interactions involving H-H interactions may be given scheduling and network bandwidth preferences over M-M or L-L. At diamond 325, it can be established that H safety labeled devices are given preference for locality operation. That is to say, local resources are assigned to H tasks first and if a constrained environment is fully allocated and there are other H operations to be performed, the next closest locality (e.g., secondary controller) will give preference to H requests and possibly forward M or L requests to a next hop away locality controller, and so forth. Based on the determination at diamond 525, control passes to diamond 530 to determine whether device D has sufficient memory resources to store a local ACL policy that names Dn as its subject. If so, control passes to block 535 where a local ACL may be created and stored in device D for device Dn. As described above, this ACL may store various fields including a subject field, a resource field and a permission field, at least. Control then passes back to diamond 515, discussed above.

Note that if it is determined at diamond 530 that device D does not have sufficient memory resources, control passes to block 540 where an administrator/user may be notified of a possible safety consideration. Responsive to this notification, a safety log may be created alerting safety auditors of network conditions that could be an indication of ‘weaknesses’ in the safety design of the network. Review of safety logs may result in a re-design of the network to remove safety gaps. Note that if at diamond 525 it is determined that the SRVs are not at least approximately equal, control passes to diamond 550. Device interactions that have safety parity (H-H) interactions are given preference over M-M or L-L. Note that H-M or H-L interactions may be given priority over M-M or L-L. Writing a safety relevant event to a log may be an instance of a H-M or H-L relationship.

At diamond 550 it may be determined whether there is a primary or secondary controller coupled to device D that has sufficient memory resources to handle maintenance of an access control policy for device Dn, and also displays low network latency to device D. With reference back to FIG. 1, such primary or secondary controllers may be located in first network portion 110 or second network portion 120, as examples. If such primary or secondary controller exists, control passes to block 560 where an access policy may be created in such controller that defines access rights for the resources of device D. Such one or more ACLs thus may be stored in or associated with such controllers.

Otherwise if at diamond 550 it is determined that there is no available primary or secondary controller, control passes to diamond 570 to determine whether device D has access to an access manager service. If so, control passes to block 580 where an access policy can be created in the access manager service that defines Dn's access rights for D's resources. Thus such ACLs may be stored and/or associated with this access manager service. If no such access manager service is available for access by device D, control instead passes to block 540, discussed above. Understand while shown at this high level in the embodiment of FIG. 5, many variations and alternatives are possible.

Embodiments may thus provide a combination of access control techniques aimed at IoT class devices that have limited resources and may have strong requirements for safe operation where network latencies may prevent existing (Internet) approaches to authorization management. More specifically, ACLs provisioned into local device memory may be used where access decisions can be evaluated quickly for requesters that are stereotyped as requiring strong safety properties. ACLs also may be provisioned in a primary or secondary controller where the ACL policy is close to the resource server in which the access decision is applied.

In embodiments, an access management service may dynamically construct a locally evaluated ACL and specify a lifetime, where subsequent requests by a given device may be honored without incurring network latency overhead within the lifetime. An access management service also may issue a token that authorizes access to a resource or a property of that resource for a one-time-use basis. Embodiments may also use an IoT network management and provisioning utility to establish a safety relevance value that is also used to manage limited device resources optimized for safe operation while also preserving secure operation. As such, an ACL representation can be distributed according to the topology of an IoT network and available device resources.

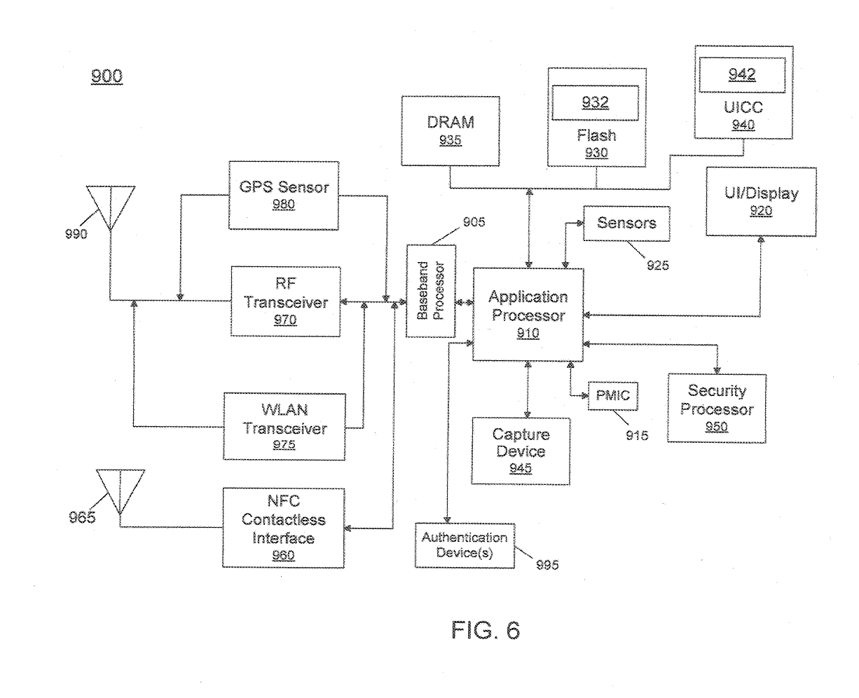

Referring now to FIG. 6, shown is a block diagram of an example system with which embodiments can be used. As seen, system 900 may be a smartphone or other wireless communicator or any other IoT device. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920, e.g., a touch screen display. In addition, application processor 910 may couple to a memory system including a non-volatile memory, namely a flash memory 930 and a system memory, namely a DRAM 935. In some embodiments, flash memory 930 may include a secure portion 932 in which secrets and other sensitive information may be stored. As further seen, application processor 910 also couples to a capture device 945 such as one or more image capture devices that can record video and/or still images.

Still referring to FIG. 6, a universal integrated circuit card (UICC) 940 comprises a subscriber identity module, which in some embodiments includes a secure storage 942 to store secure user information. System 900 may further include a security processor 950 that may implement a TEE as described earlier, and which may couple to application processor 910. Furthermore, application processor 910 may implement a secure mode of operation, such as Intel® SGX for hosting of a TEE, as described earlier. A plurality of sensors 925, including one or more multi-axis accelerometers may couple to application processor 910 to enable input of a variety of sensed information such as motion and other environmental information. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 6, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received such as in one or more IoT networks, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein when context information is to be used in a pairing process. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

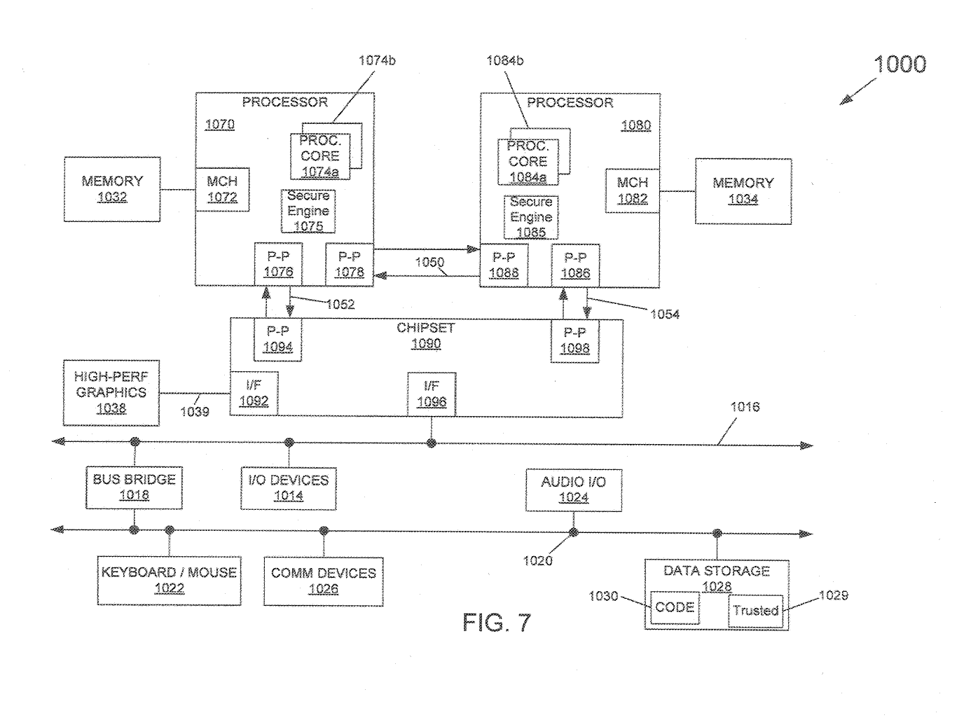

Referring now to FIG. 7, shown is a block diagram of a system in accordance with another embodiment of the present invention. As shown in FIG. 7, multiprocessor system 1000 is a point-to-point interconnect system such as a server system, and includes a first processor 1070 and a second processor 1080 coupled via a point-to-point interconnect 1050. As shown in FIG. 7, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include a secure engine 1075 and 1085 to perform security operations such as attestations, IoT network onboarding or so forth.

Still referring to FIG. 7, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 7, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 7, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 7, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device. As seen, data storage unit 1028 may include code 1030, in one embodiment. As further seen, data storage unit 1028 also includes a trusted storage 1029 to store sensitive information to be protected. Further, an audio I/O 1024 may be coupled to second bus 1020.

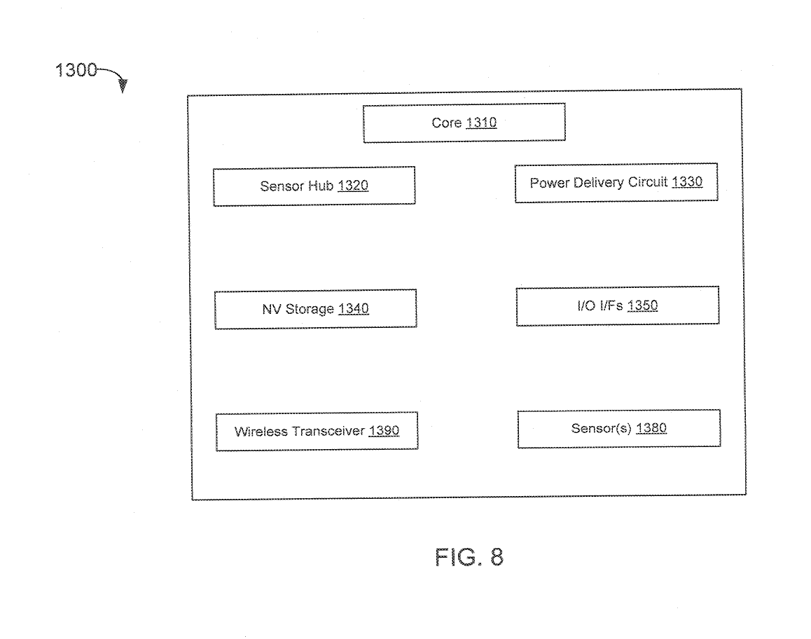

Embodiments may be used in environments where IoT devices may include wearable devices or other small form factor IoT devices. Referring now to FIG. 8, shown is a block diagram of a wearable module 1300 in accordance with another embodiment. In one particular implementation, module 1300 may be an Intel® Curie™ module that includes multiple components adapted within a single small module that can be implemented as all or part of a wearable device. As seen, module 1300 includes a core 1310 (of course in other embodiments more than one core may be present). Such core may be a relatively low complexity in-order core, such as based on an Intel Architecture® Quark™ design. In some embodiments, core 1310 may implement a TEE as described herein. Core 1310 couples to various components including a sensor hub 1320, which may be configured to interact with a plurality of sensors 1380, such as one or more biometric, motion environmental or other sensors. A power delivery circuit 1330 is present, along with a non-volatile storage 1340. In an embodiment, this circuit may include a rechargeable battery and a recharging circuit, which may in one embodiment receive charging power wirelessly. One or more input/output (IO) interfaces 1350, such as one or more interfaces compatible with one or more of USB/SPI/I²C/GPIO protocols, may be present. In addition, a wireless transceiver 1390, which may be a Bluetooth™ low energy or other short-range wireless transceiver is present to enable wireless communications as described herein. Understand that in different implementations a wearable module can take many other forms.

A capability list is a right granted to an IoT client such that a condition of access is specified in terms of a target resource instance, resource type, resource interface, resource instance, etc. The client may seek to access a resource using a role and/or device identity. To determine whether access is to be granted, an entity may determine whether an access control entry (ACE) and having as a subject the client, where the ACE is associated with an access control list (ACL), is aligned with the capability right granted to the client (including the subject of the ACE policy). In embodiments, ACE policy may identify a (local or remote) resource instance, resource type and resource interface through which the subject (e.g., client) is permitted access to the local or remote resource.

In the case of a named local or remote resource in an ACE policy, the entity applying the access policy (e.g., a Secure Resource Manager (SRM)) may be configured as a policy enforcement point (PEP) that is a choke point such that access to the resource by the client is prevented by the PEP. In the case of a remote resource, the PEP may be a network choke point or firewall such that a network route from the client to the resource circumventing the PEP does not exist. In embodiments, the PEP may also share a trusted path connection with the resource host such that the PEP is permitted access to the remote resource for the purpose of allowing/denying access on behalf of the requesting client. Although the scope of the present invention is not limited in this regard, the type of access may be specified in terms of a RESTful interface semantic, where RESTful-ness implies a stateless model for communication and may be summarized as CRUDN (Create, Read, Update, Delete, Notify) or CRUDNO (Create, Read, Update, Delete, Notify and Observe). Note that Notify is a special case of Update, and Observe is a special case of Read. These special case privileges may be implemented in a distributed computing model to synchronize distributed objects.

Distributed access control in an IoT network may involve a distributed set of clients (entities that request access to resources) and servers (entities that supply resource requests). System services may be used to coordinate permissible interaction between clients and servers.

In one particular embodiment, a network may include a collection of computing devices. This network, such as a network of interconnected devices including IoT devices (e.g., client) and one or more service-based systems (e.g., servers), may provide multiple entities that enable services for performing access control interactions. In one such embodiment, a Credential Management Service (CMS) may be configured to grant credentials to clients and servers for establishment of encrypted and integrity protected sessions, messages and stored data. A second specialization is the granting and expiration of capability rights, which may be performed by a Rights Management Service (RMS). A third specialization is assignment of access control policies for resources, which may be performed by an Access Management Service (AMS). The CMS, RMS and AMS functions may be shared or distributed among one or more host computer systems. Their function is itself a role designation that may be included in a capability right. Hence, a client may double as a system service host.

A client possessing a capability right may assert that right using different methods in different embodiments. For example, a client may present a digital certificate, ticket or stored policy identifying the client and/or client role(s) and may include a capability listing of allowed access to named resources, resource types and/or resource interfaces.

As used herein, a certificate is an asymmetrically signed data structure that contains capability contents. Such certificate may be verified by the PEP by matching a signer's public key to a signing key. One possible asymmetric key type may be a group asymmetric key such as an Intel® Enhanced Privacy ID (EPID), which may be used in this context to specify a client grouping. As examples, a group or domain may be established in terms of a particular role (e.g., administrator) or function (e.g., chiller controller) or deployment context (e.g., building 7, floor 10). A private key typically accompanies a certificate and is used to perform a key exchange protocol that results in generation of a symmetric key used to confidentiality and integrity protect a message.

As used herein, a ticket is a symmetrically signed data structure that contains capability contents and a symmetric key used to confidentiality and integrity protect a message. A ticket may also contain an encrypted copy of the symmetric key used to verify and decrypt the message by the PEP.

A PEP may also maintain stored credentials and policies used in connection with authenticated message exchange with a client. Stored policies may contain details of the capability of a client should the client present a certificate or ticket having no explicit capability information. An RMS may provision a stored capability policy to the PEP.

An ACE policy may include a local or remote reference to a resource, type of resource, and/or interface definition of a resource. In an embodiment, such ACE policy may be digitally signed by an AMS and distributed to the resource server and subsequently presented to a PEP. In other cases, the AMS may provision the ACE directly to the PEP. In still other cases, an ACE policy may withhold specification of the resource reference and/or combination of resource type and resource interface so as to cause the PEP to proactively interact with the AMS to resolve an access request. This approach may be useful when optimizing for extremely dynamic environments where resource hosts arrive and depart frequently.

Thus in various embodiments, client capabilities can be expressed using a certificate, ticket or stored policy. Capabilities may be configured to semantically align to ACE policies such that a gradient of coarse-to-fine granularity access policy may be expressed and enforced. An example of coarse-to-granular access policy is a ‘type enforcement’ where a typing system is defined such that source and target may interact within the constraints of the type structure.

For example, assume a firewall filters on port 80, where it is understood that port 80 will host web traffic. The firewall may establish ‘web traffic’ as the type constraint. In embodiments, the IoT framework that defines resource type may be used to specify the type constraint. And the interface may also be construed as a type constraint. In a further embodiment of type enforcements, the resource itself may be a type constraint, given the understanding that resources offer an abstraction of the capabilities of an underlying entity.

For example, a thermostat resource may provide an abstraction by which a client may view a refrigerator entity containing a thermometer. A type enforcement rule based on a thermostat resource suggests that a client is restricted to a set of controls over the refrigerator that may involve reading of temperature and setting of temperature. A capability right to this resource suggests a restriction to a particular set of message exchanges. Use of an EPID group key as the credential suggests that the capability specifying the thermostat resource may be authorized by all thermostats who are members of the ‘thermostat’ group and share an EPID group key.

As an example, ACE structure may be provided where a target resource is expressed using the same schema that originally defines the resource in terms of its URL reference, resource type name, interface definition and device identifier. A given capability structure may be provided, where the subject is expressed using the same schema that originally defines the resource in terms of its URL reference, resource type name, interface definition and device identifier. As such, a matching function may be performed to relate the capability expression to the ACE expression.

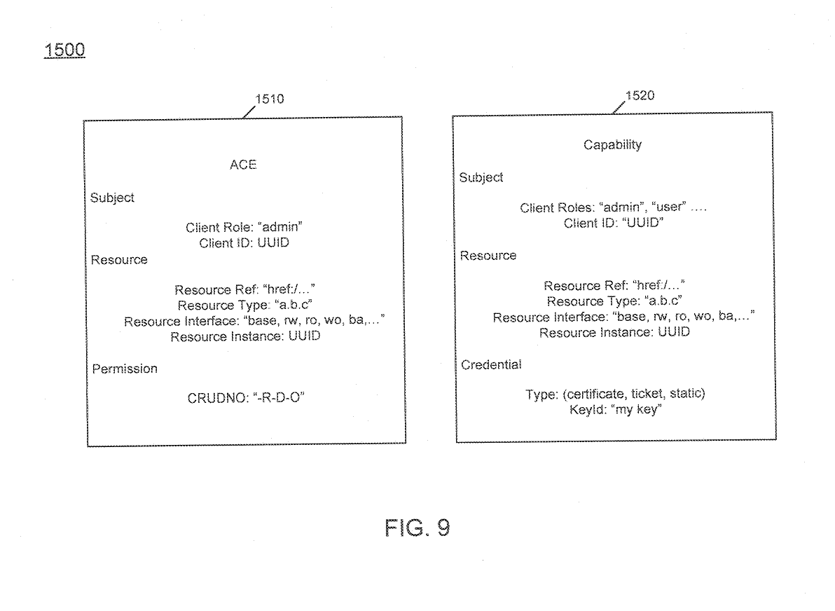

Referring now to FIG. 9, shown is a block diagram illustrating example ACE and capability records showing fields for matching client (subject) to resource in accordance with an embodiment. As shown in FIG. 9, an ACE 1510 may be associated with a particular subject, as indicated by information of a subject field in ACE 1510. ACE 1510 further includes resource and permission fields. Based on at least some of the information of these various fields of ACE 1510, a given PEP can make an access control decision as to whether access to a particular resource by the requester (subject) is to be allowed. Similarly, a capability record 1520 may be associated with a particular subject. As seen, capability record 1520 includes subject, resource, and credential fields.

With reference back to ACE 1510, subject information includes a client role and a client ID, which in an embodiment may be a universally unique identifier (UUID). In turn, resource information may include a resource reference, resource type, resource interface and resource instance. In the embodiments shown, the resource reference may be a reference to a given hyperlink, which may correspond to a requested resource. In turn, resource type may include various information regarding a type of resource requested. In turn, a resource interface may provide information regarding a RESTful interface semantic. For example, a ‘read-write’ interface semantic would allow RESTful GET and PUT commands while excluding CREATE, UPDATE, NOTIFY and OBSERVE. Still another interface semantic ‘batch’ would allow a RESTful command applied to a first resource to be propagated to a second resource referenced by a first resource to apply the property of transitivity. Finally, the resource instance may provide an identifier of the resource, which may be a UUID. Finally, permission information may provide one or more types of permission of a given policy enforcement scheme, e.g., in the example shown ACE 1510 enables read (R), delete (D), and observe (O) permissions.

With reference now to capability record 1520, subject information may include client roles and client ID. In turn, the resource information of capability record 1520 may include the same fields as in ACE 1510. Finally, capability record 1520 includes credential information, which may include a type field to indicate a type of credential (such as a certificate, ticket, static credential or so forth) and a key identifier field, which may provide, e.g., a group public key for the associated requester. Understand while shown with this particular information in the embodiment of FIG. 9, many variations and alternatives are possible.

As seen, a number of parameters of type-enforced access can be described (e.g., resource reference, resource type, and resource interface, and resource instance within an ACE). Client identity may be defined in terms of a client device ID and/or a role (group) to which the client belongs. The PEP evaluates access by matching the capability subject to ACE subject. In an embodiment, the client roles dominate (are a superset of) the ACE client role. The client ID values, if supplied, are to match exactly. If a match exists, the resource information is evaluated. The intersection of both defines the range of access. Intersection defines a type enforcement granularity constraint. If both records include a resource type of “a.b.c,” then the client may access all resources of type “a.b.c”. If resource sections are blank, then no access is authorized, in an embodiment. A wild-card/regular expression value “*” may be supplied that matches any value, thus granting no restriction on the matching scope. For example, Java Script Object Notation (JSON) schema may permit a regular expression defining a pattern for matching characters of a string that allows greater matching flexibility than exactly matching a specified string value. If a match is found, the PEP applies the permission defined in the ACE. The client is authenticated using a credential described by the capability. A credential resource contains the credential values used to establish a secure session or to protect messages containing the resource requests and resource responses. In an embodiment, authentication of the client may occur before performing the matching hierarchy described above.

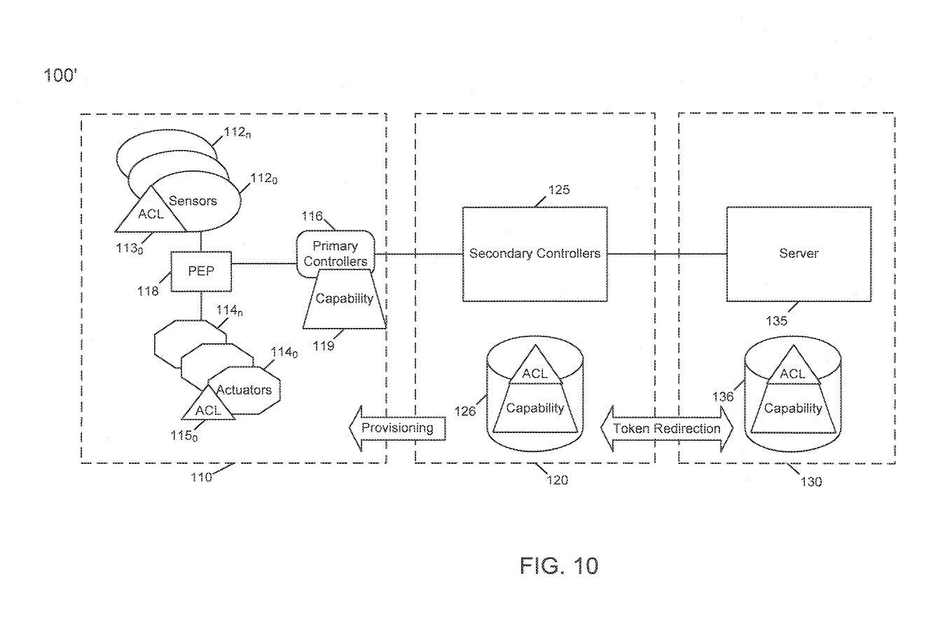

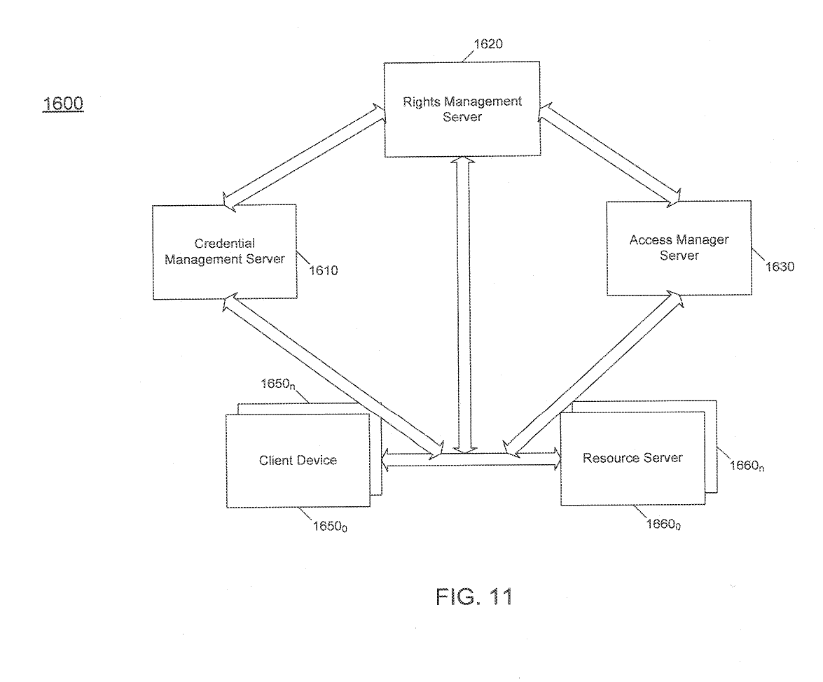

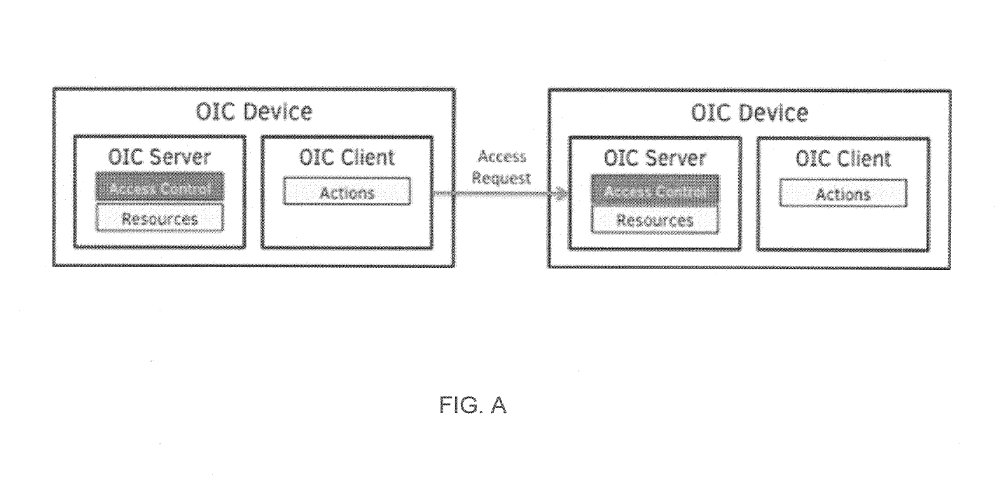

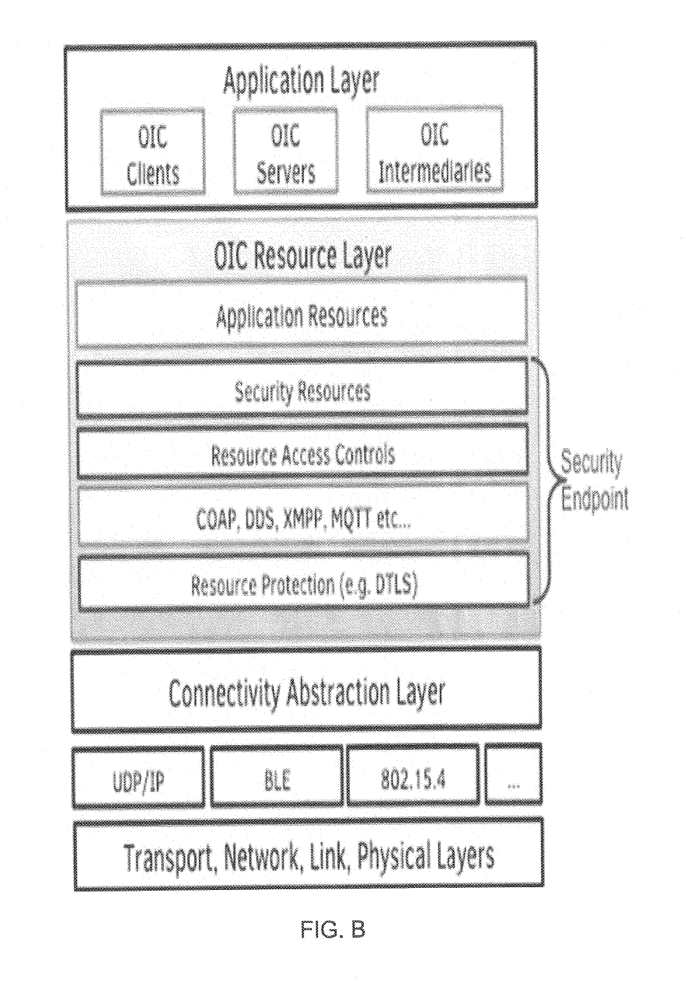

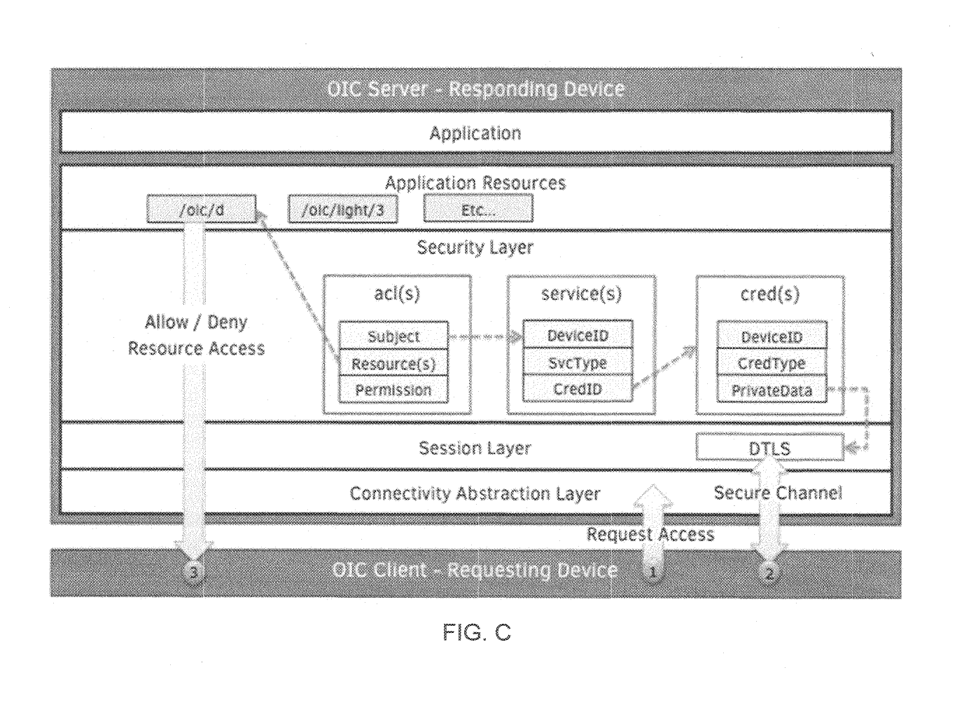

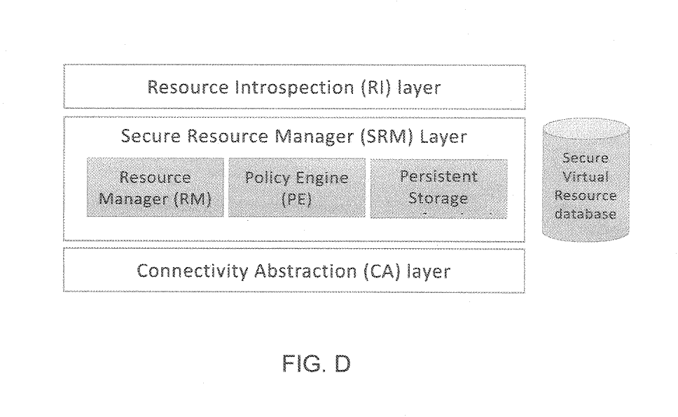

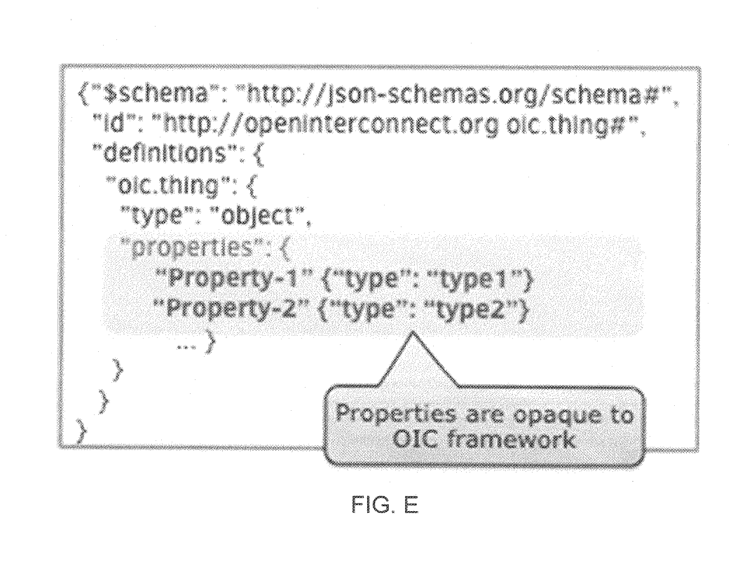

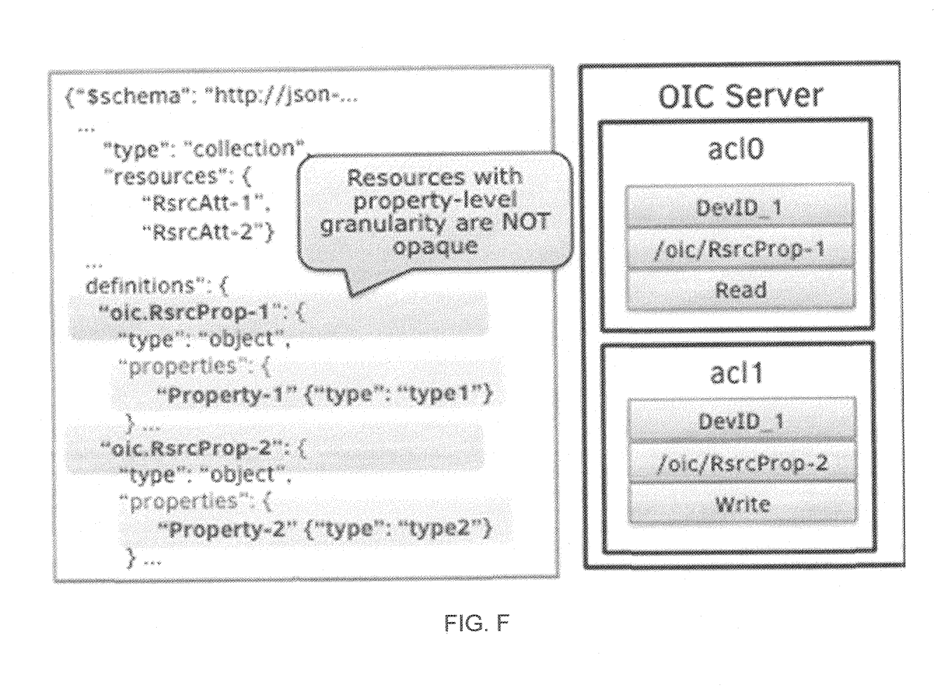

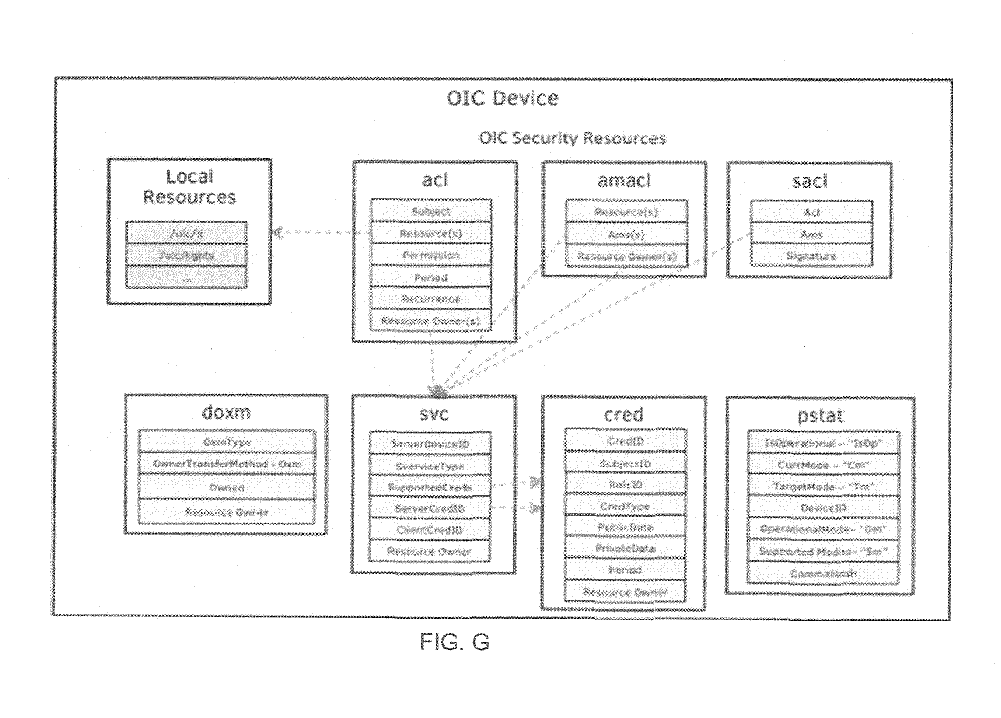

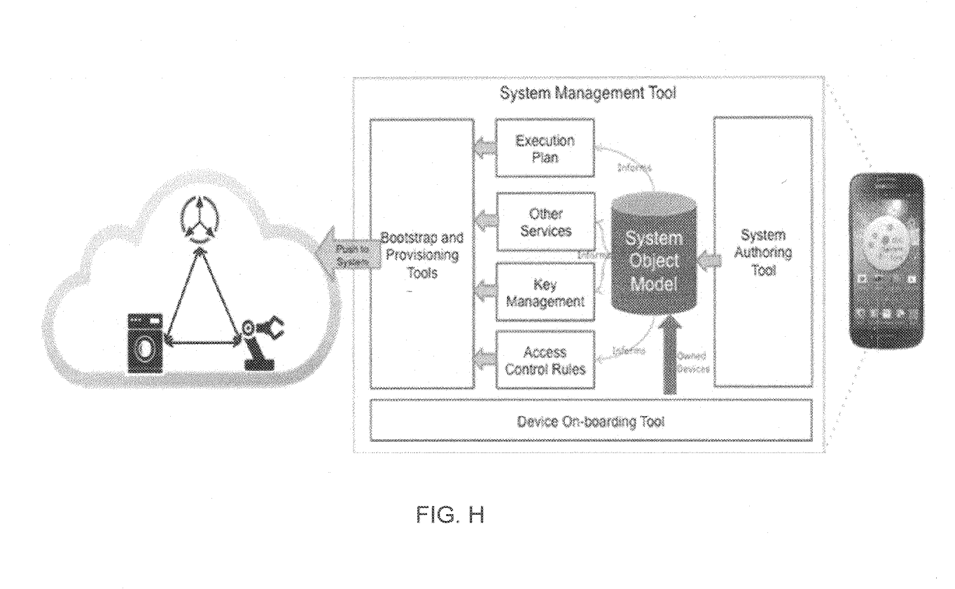

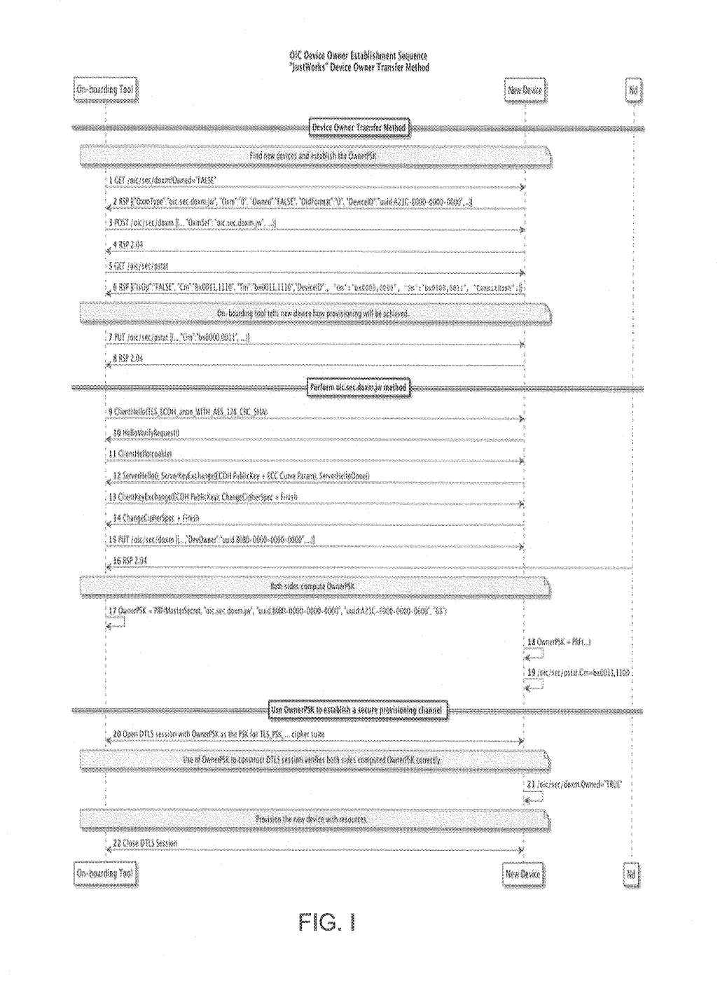

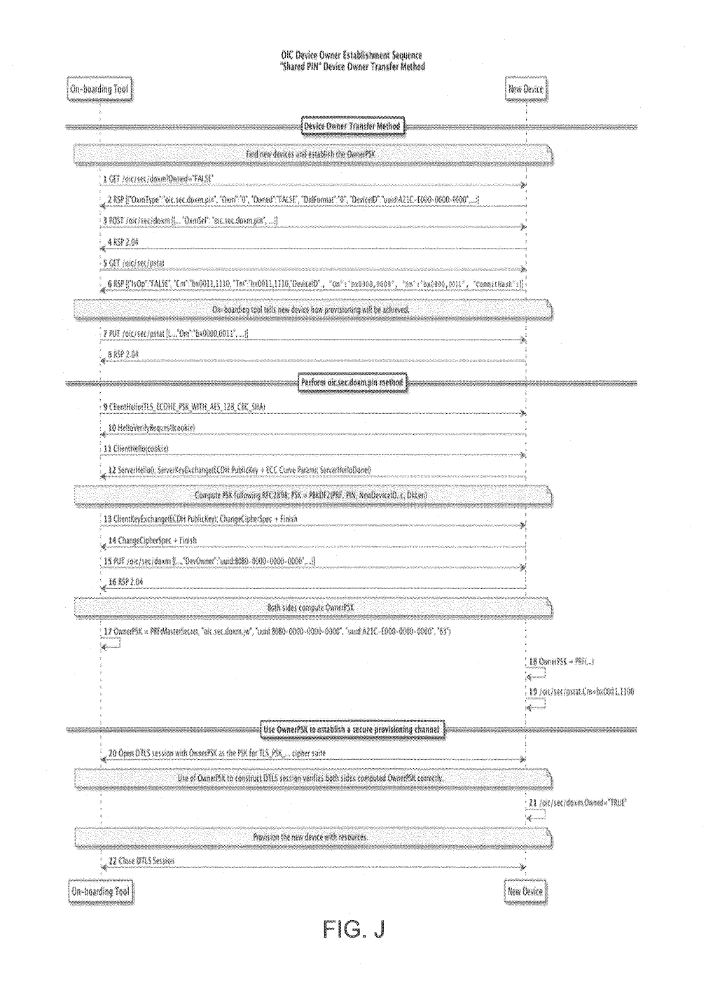

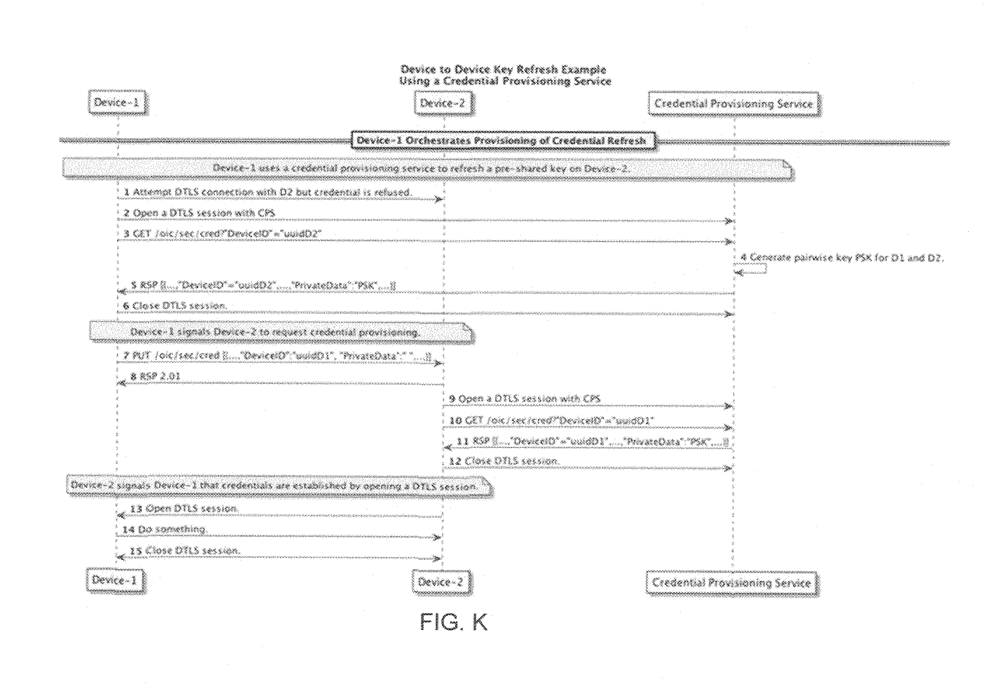

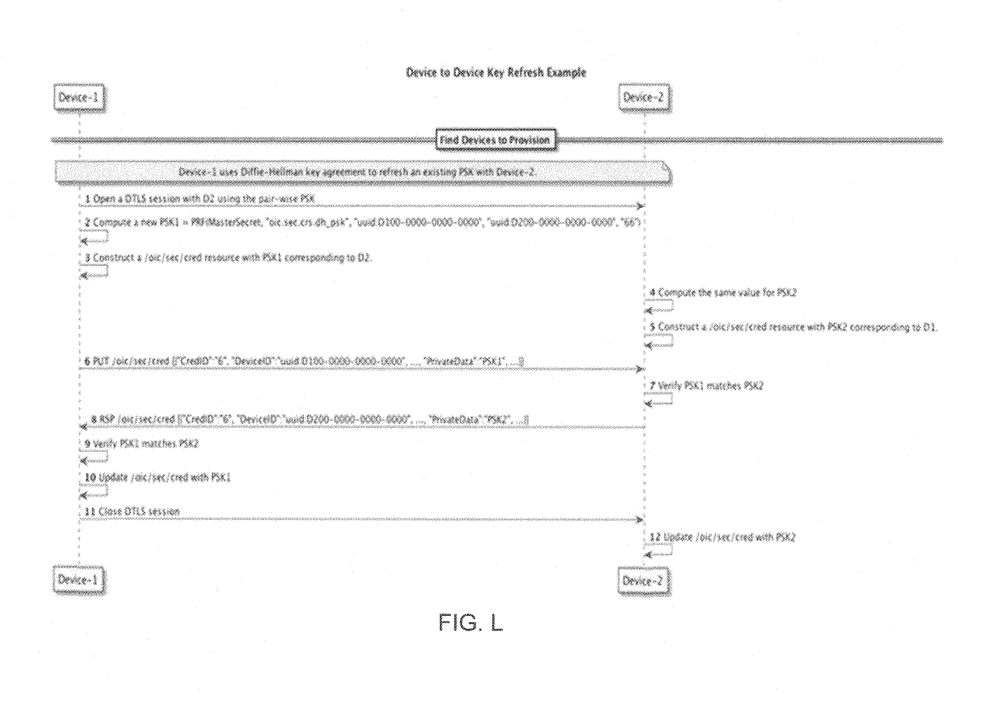

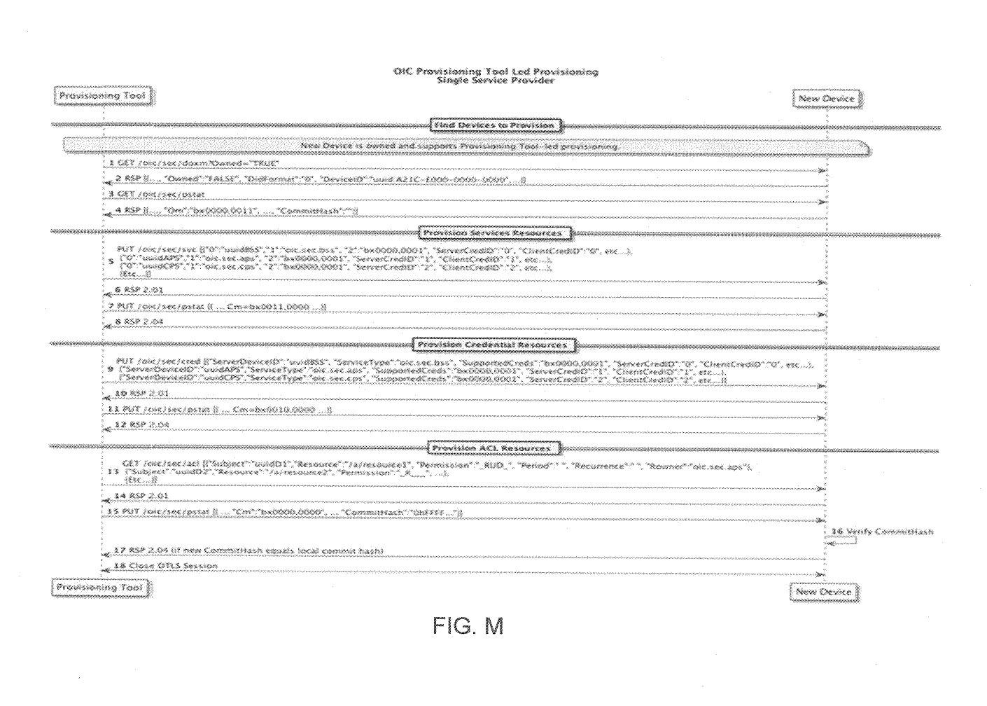

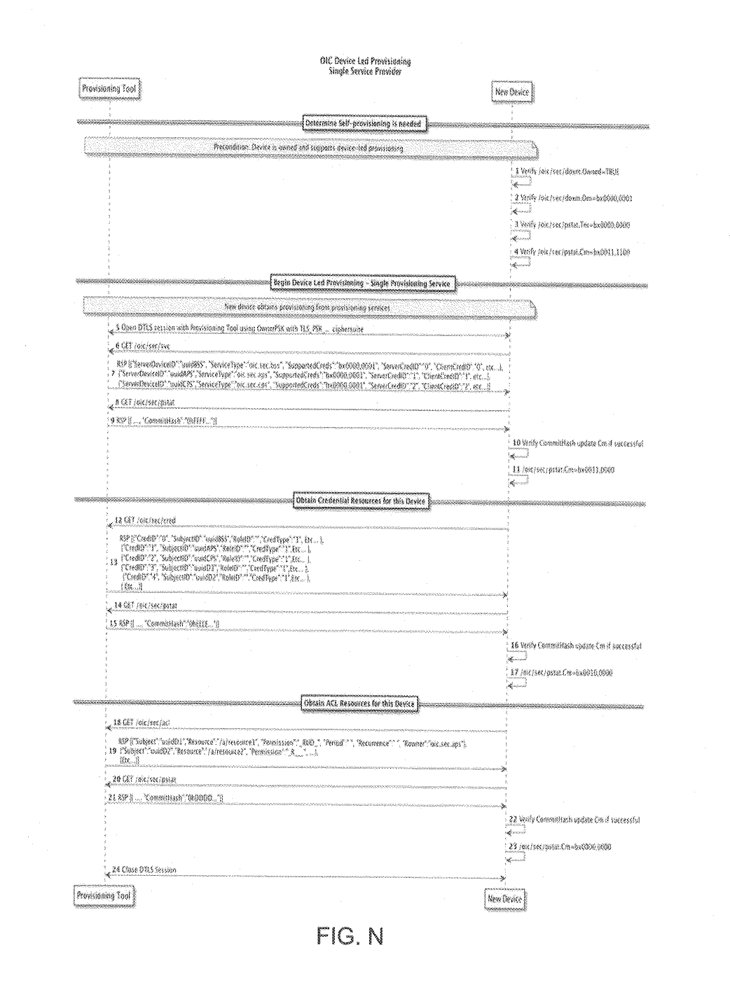

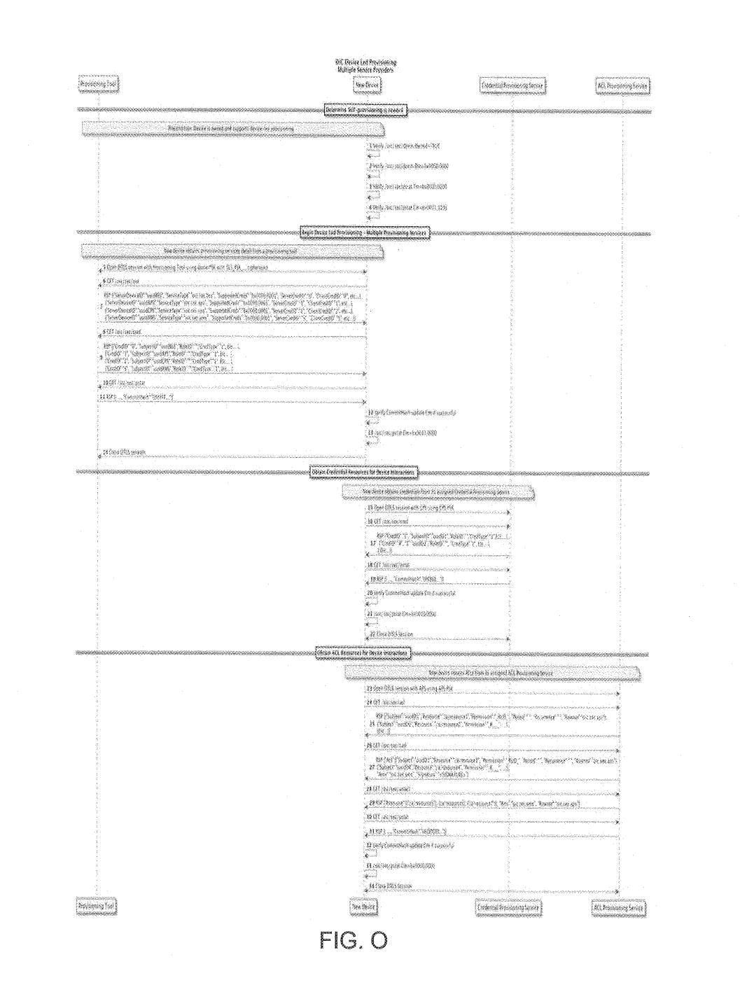

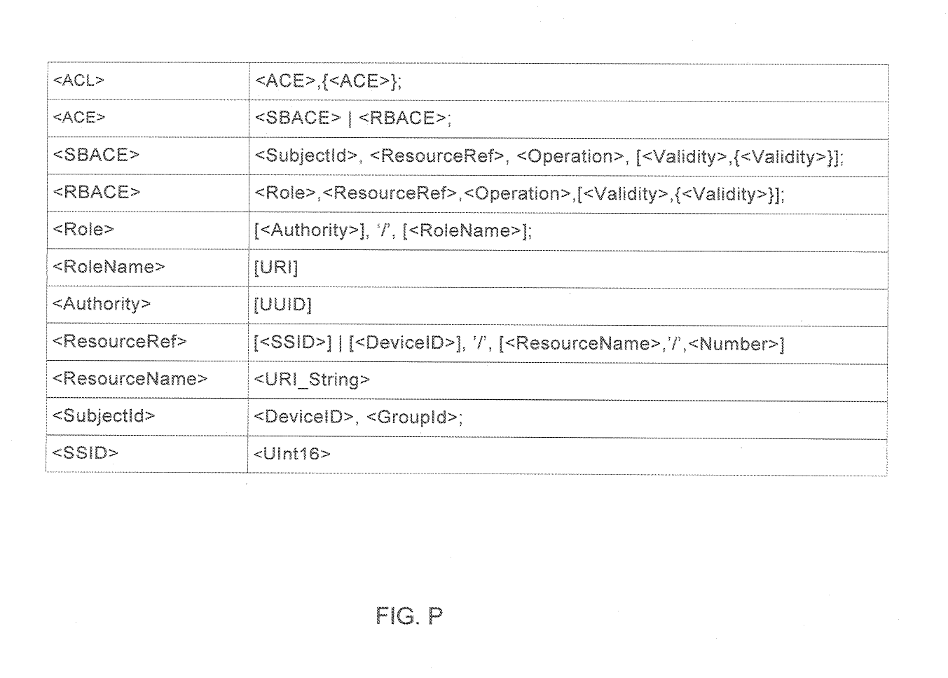

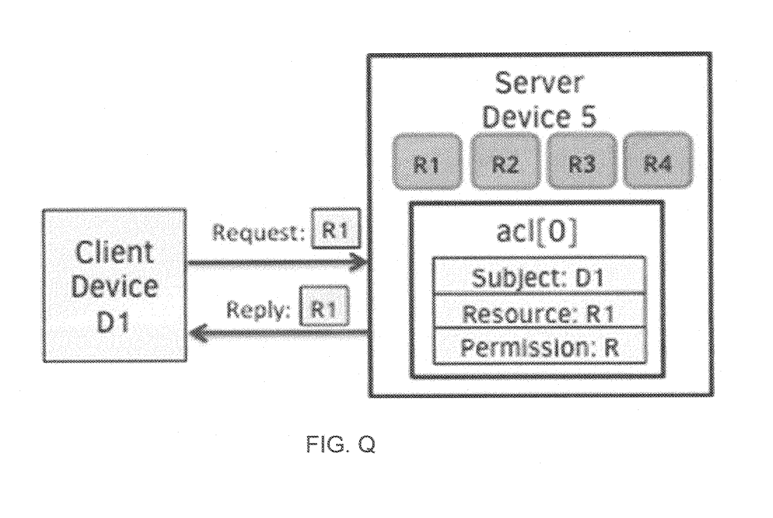

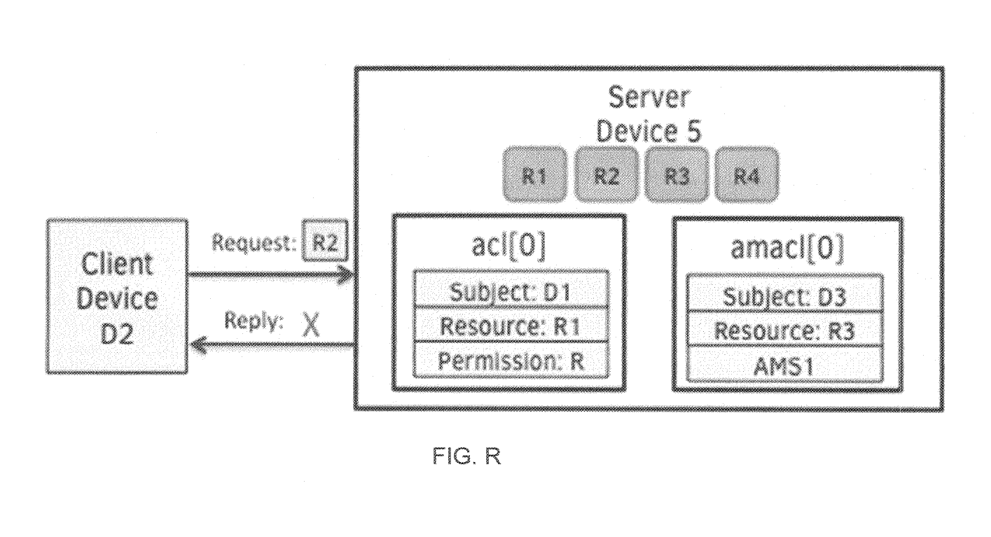

Referring now to FIG. 10, shown is a block diagram of a system in accordance with another embodiment of the present invention. Note that system 100′ of FIG. 10 may be an IoT network generally configured similarly as system 100 of FIG. 1. As such, only relevant variations in system 100′ are described herein.

As illustrated, within first network portion 110, a policy enforcement point (PEP) 118 is provided. As seen, PEP 118 couples between primary controllers 116 and corresponding sensors 112 and actuators 114. Any IoT device type may be overloaded to enforce a security policy as a PEP, given that a connectivity topology of subordinate devices relative to a first device forms a choke point in the network. As such a second device may not reach a subordinate device except through the first device. An endpoint device is naturally a PEP for resources locally hosted. In some embodiments, secondary controllers 125 may provide for one or more of AMS, CMS and/or RMS services, as described herein. As further illustrated, a capability token 119 may be used to assign client rights. A corresponding capability token 119, also referred to herein as a capability record, may provide various information, including subject information, resource information, and credential information as described herein. In embodiments, each IoT device (e.g., sensors 112 and actuators 114) may be associated with a corresponding capability record. Such capability record may be provisioned and stored, e.g., in a secure storage of the device itself. In other cases, such capability record may be provisioned to and maintained in primary controllers 116. In any event, each client may possess a capability such that a server may apply an ACE policy that matches the capability rights granted. For example, a capability expression of ‘admin’ and ‘a.b.c’ would match an ACE policy permitting administrator privileges for devices of type ‘a.b.c’. In embodiments, a central repository may be provided for a user to maintain a capability policy (and update it). However, each individual client entity can be issued a credential (e.g., certificate, ticket or static file) containing the capability assignment. In the case of a file, the server may open a secure (e.g., datagram transport layer security (DTLS)) session to the host entity to read the capability for a given client.

As further illustrated in FIG. 10, in second network portion 120 and third network portion 130, capability records may be received in connection with requests for access to resources protected by devices in these portions of a network. In some embodiments, primary controllers 116 may provide AMS services, at least for a subset of protected resources. As such, access control decisions may be made, e.g., in corresponding secondary controllers 125 and/or server 135 based on a matching or other comparison between information in a capability record associated with a request from a particular subject and a corresponding ACE for the corresponding requester stored in an ACL.

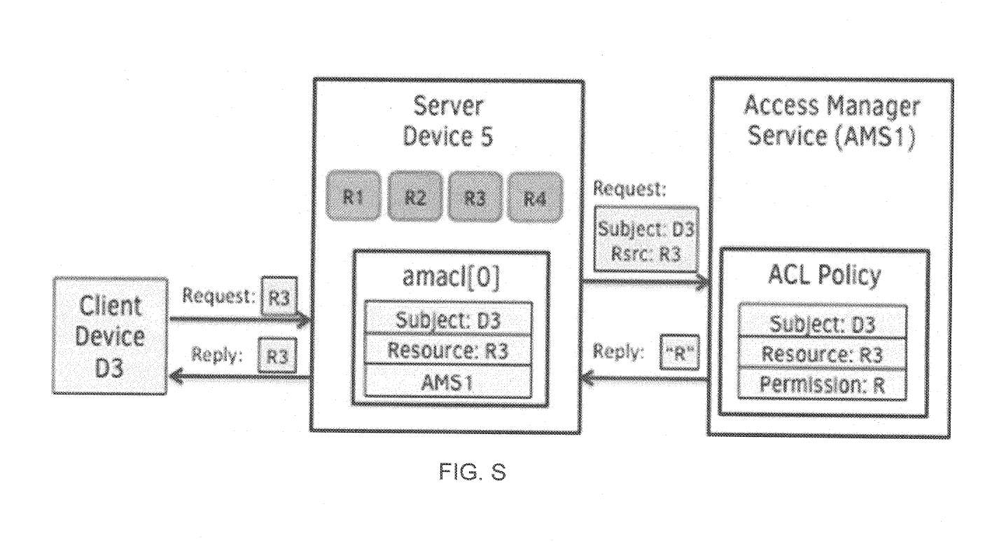

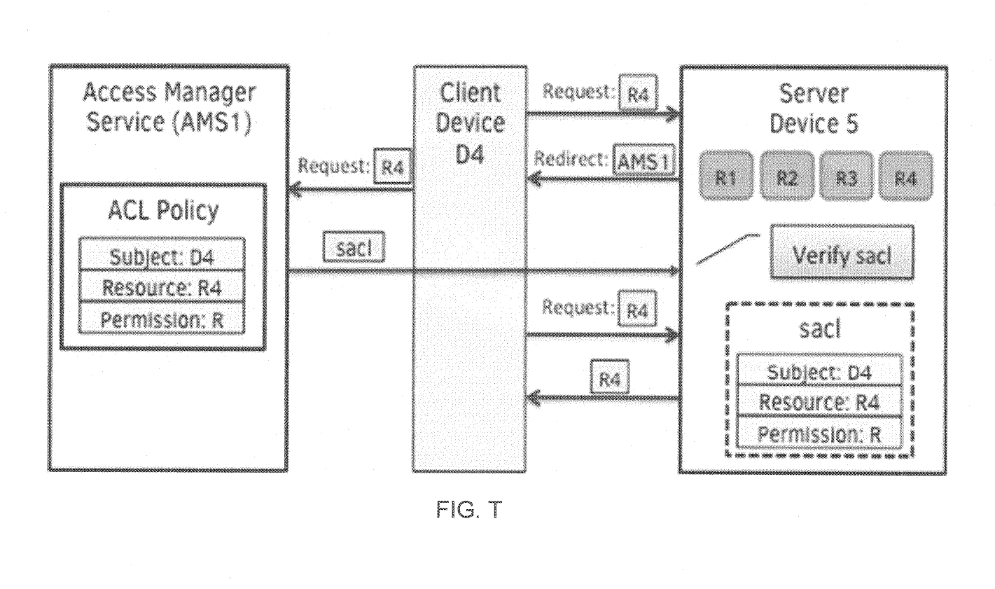

Referring now to FIG. 11, shown is a block diagram of a computer network in accordance with an embodiment of the present invention. More specifically as shown in FIG. 11, network 1600 may be all or a portion of an interconnected arrangement of various computing devices, including different manager services as described herein, along with client devices such as a variety of different IoT devices and resource services. Based on communications within network 1600, client devices can be provided access to underlying resources, either included in or locally available to the corresponding resource services in a secure and efficient manner.

As illustrated, network 1600 includes a credential management server (CMS) 1610. In different implementations CMS 1610 may be implemented as all or a portion of one or more server computers, e.g., located at a cloud-based location or locally, e.g., in an enterprise environment having an IoT network to be locally controlled and protected. As such credential manager server 1610 may include various hardware, including one or more hardware processors, memory, storage resources, communication hardware and so forth. Credential management server 1610 may perform creation, granting and management of credentials provided to one or more of client devices 1650₀-1650ₙ and resource servers 1660₀-1660ₙ, as described herein.

Client devices 1650₀-1650ₙ may take any form of computing devices. In some embodiments, at least some of client devices 1650 may be relatively limited compute complexity IoT devices, such as sensors, actuators or so forth. In other arrangements, client devices 1650 may include other types of constrained environment devices. In turn, resource servers 1660 may provide access, based on appropriate provisioning as described herein, to underlying resources. Such resources may be included locally within resource servers 1660 or may be located in, e.g., one or more local storages associated with such resource service. In embodiments, a resource server 1660 may be implemented as all or portions of one or more servers, including combinations of one or more hardware processors, memory, storage, communication hardware and so forth.

As further illustrated in FIG. 11, rights management server 1620 may be implemented as one or more server computers (and which may be distributed systems also performing credential management services, in some cases). Rights management server 1620 may be configured to grant capability rights to given IoT devices. As examples, rights management server 1620 may dynamically grant a capability record for a device when it is provisioned into a domain, and then cause this record to be rescinded, e.g., when the device leaves the domain. In different embodiments, rights management server 1620 may provision such capability record (containing a capability assignment) directly to the client device, a controller associated with the device, and/or a policy enforcement point, depending on type of client device and network topology. In some cases a DTLS connection to a network service (or device hosting a network service) may be used to maintain a static capability policy, where a network service may be regarded as a PEP if topology requirements are met.

In addition, network 1600 further includes an access manager server 1630. In various embodiments, access manager server 1630 may assign access control policies for given resources, e.g., as protected by resource servers 1660. In different embodiments, access management server 1630 may be implemented as one or more server computers (and which may be distributed systems also performing one or more of credential management services and rights management services, in some cases).

Thus with the arrangement illustrated in FIG. 11, a wide variety of devices can communicate with each other to enable client devices 1650 to access various resources associated with resource servers 1660 in a secure and efficient manner. Understand while shown with this particular implementation in the embodiment of FIG. 11, many variations and alternatives are possible.

The following Examples pertain to further embodiments.

In Example 1, a method comprises: identifying a first request received from a first client device to access a first resource of a system, determining whether to grant access to the first resource based on a first access control entry in a first access control list stored in the system, the first access control entry having the first client device as a subject, the first access control entry to identify the first resource and to indicate a permission type for the first resource, and granting the access to the first resource based on the determination, where the system comprises a server device; identifying a second request received from a second client device to access a second resource of the system and denying access to the second resource responsive to a determination that no access control policy is present in the system for the second resource; identifying a third request received from a third client device to access a third resource of the system and forwarding the third request to an access manager service coupled to the system in response to a determination that a second access control entry of a second access control list stored in the system indicates that the system is to consult the access manager service, the second access control entry having the third client device as a subject and to identify the third resource and the access manager service; and granting the third client device access to the third resource in response to a reply received from the access manager service.

In Example 2, the method further comprises preventing the second client device from access to the second resource via at least one of a firewall or a network choke point.

In Example 3, the first request comprises a first capability record of the first client device, the first capability record to identify subject information of the first client device, resource information comprising a resource reference, a resource type and a resource interface, and credential information, the resource reference, the resource type and the resource interface of the first capability record expressed with a first schema corresponding to a second schema that defines the first resource.

In Example 4, the credential information comprises an asymmetrically signed certificate signed by a group private key of the first client device, and where the method further comprises verifying the asymmetrically signed certificate via a group public key of a domain including the first client device.

In Example 5, the method further comprises verifying the asymmetrically signed certificate before determining whether to grant the access to the first resource.

In Example 6, the method further comprises comparing at least a portion of the subject information of the first capability record to subject information of the first access control entry, comparing the resource information of the first credential record to resource information of the first access control entry, and based on the comparison, granting the access according to the permission type.

In Example 7, the method further comprises authenticating the first client device before the comparison is to be performed.

In Example 8, the method further comprises decrypting a ticket including the credential information using a symmetric key.

In Example 9, a system comprises: a credential management server including at least one first hardware processor to provide credentials to a plurality of computing devices and a plurality of resource servers; a rights management server including at least one second hardware processor to grant capability rights to the plurality of computing devices; and an access management server including at least one third hardware processor to assign access control policies for a plurality of resources to be protected by the plurality of resource servers, where a first resource server of the plurality of resource servers is to receive a first access request for access to a first resource of the plurality of resources from a first computing device of the plurality of computing devices and send the first access request to the access management server for determination of whether to grant a permission for the access to the first resource.

In Example 10, the system comprises a first server comprising at least two of the credential management server, the rights management server, and the access management server.

In Example 11, the credential management server is to provision a first capability record to the first computing device, the first capability record including subject information of the first client device, resource information comprising a resource reference, a resource type and a resource interface, and credential information.

In Example 12, the first computing device is to be provided access to a first plurality of resources of a first type based at least in part on the resource type included in the first capability record.

In Example 13, the first computing device is to provide a certificate to the first resource server, the first resource server to authenticate the first computing device based on the certificate using a group public key associated with a domain including the first computing device.

In Example 14, the first resource server is to grant the first computing device access to a second resource after the authentication and based at least in part on information in an access control entry provisioned into the first resource server from the access management server.

In Example 15, a method comprises: identifying a first request received from a first client device to access a first resource of a system, where at a time of receipt of the first request, the system does not store an access control list associated with the first client device, where the system comprises a server device; sending a message to the first client device, to identify an access manager service and redirect the first client device to send a second request to the access manager service, the access manager service comprising a signed access control list issuer; obtaining the access control list from the first client device and storing the access control list in the system, where the first client device obtained the access control list from the access manager service; and identifying a second request received from the first client device to access the first resource and determining whether to grant access to the first resource based on a first access control entry in the access control list stored in the system, the first access control entry having the first client device as a subject, the first access control entry to identify the first resource and to indicate a permission type for the first resource, and granting the access to the first resource based on the determination.

In Example 16, the first request comprises a first capability record of the first client device, the first capability record to identify subject information of the first client device, resource information comprising a resource reference, a resource type and a resource interface, and credential information.

In Example 17, the credential information comprises an asymmetrically signed certificate, the asymmetrically signed certificate signed by a group private key of the first client device, and further comprising verifying the asymmetrically signed certificate via a group public key of a domain including the first client device.

In Example 18, the method further comprises verifying the asymmetrically signed certificate before determining whether to grant the access to the first resource.

In Example 19, the method further comprises: identifying a third request received from a second client device to access a second resource of the system, determining whether to grant access to the second resource based on a first access control entry in a second access control list stored in the system, the first access control entry having the second client device as a subject, the first access control entry to identify the second resource and to indicate a permission type for the second resource, and granting the access to the second resource based on the determination; and identifying a fourth request received from a third client device to access a third resource of the system and denying access to the third resource responsive to a determination that no access control policy is present in the system for the third resource.

In Example 20, the method further comprises: identifying a fifth request received from a fourth client device to access a fourth resource of the system and forwarding the fifth request to the access manager service in response to a determination that a second access control entry of a second access control list stored in the system indicates that the system is to consult the access manager service, the second access control entry having the fourth client device as a subject and to identify the fourth resource and the access manager service; and granting the fourth client device access to the fourth resource in response to a reply received from the access manager service.

In Example 21, an apparatus comprises: means for identifying a first request received from a first client device to access a first resource, means for determining whether to grant access to the first resource based on a first access control entry in a first access control list, the first access control entry having the first client device as a subject, the first access control entry to identify the first resource and to indicate a permission type for the first resource, and means for granting the access to the first resource based on the determination; means for identifying a second request received from a second client device to access a second resource and means for denying access to the second resource responsive to a determination that no access control policy is present for the second resource; means for identifying a third request received from a third client device to access a third resource of the system and means for forwarding the third request to an access manager service in response to a determination that a second access control entry of a second access control list indicates that the apparatus is to consult the access manager service, the second access control entry having the third client device as a subject and to identify the third resource and the access manager service; and means for granting the third client device access to the third resource in response to a reply received from the access manager service.

In Example 24, the first request comprises a first capability record of the first client device, the first capability record to identify subject information of the first client device, resource information comprising a resource reference, a resource type and a resource interface, and credential information, the resource reference, the resource type and the resource interface of the first capability record expressed with a first schema corresponding to a second schema that defines the first resource.

In Example 25, the credential information comprises an asymmetrically signed certificate, the asymmetrically signed certificate signed by a group private key of the first client device, and further comprising means for verifying the asymmetrically signed certificate via a group public key of a domain including the first client device.

In Example 26, the apparatus further comprises means for comparing at least a portion of the subject information of the first capability record to subject information of the first access control entry, means for comparing the resource information of the first credential record to resource information of the first access control entry, and means for granting the access according to the permission type.

In Example 27, a method comprises: responsive to a first request from a first client device to access a first resource of a system, granting access to the first resource based on a first access control entry in a first access control list stored in the system, the first access control entry having the first client device as a subject and to identify the first resource and indicate a permission type for the first resource, where the system comprises a server device; responsive to a second request from a second client device to access a second resource of the system, denying access to the second resource responsive to absence of an access control policy in the system for the second resource; sending a third request from a third client device to access a third resource of the system to an access manager service of an access manager server in response to an indication in a second access control entry of a second access control list stored in the system that the system is to consult the access manager service of the access manager server, the second access control entry having the third client device as a subject and to identify the third resource and the access manager service; and sending a reply to the third client device to indicate access to the third resource in response to a reply received from the access manager service.

In another example, a computer readable medium including instructions is to perform the method of any of the above Examples.

In other examples, a computer readable medium including data is to be used by at least one machine to fabricate at least one integrated circuit to perform the method of any one of the above Examples.

In other examples, an apparatus comprises means for performing the method of any one of the above Examples.

Understand that various combinations of the above Examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

The following Appendix of information includes additional subject matter that forms part of the disclosure and may be usable in various embodiments.

### TERMS, DEFINITIONS, SYMBOLS AND ABBREVIATIONS

Terms, definitions, symbols and abbreviations used in this specification are defined by the OIC Core specification. Terms specific to normative security mechanism are defined in this document in context. This section restates terminology that is defined elsewhere, in this document or in other OIC specifications as a convenience for the reader. It is considered non-normative.

TABLE 1
Terminology

| Term | Description |
|---|---|
| Access Manager | The Access Manager Service dynamically constructs ACL |
| Service | resources in response to a device resource request. An Access |
| | Manager Service can evaluate access policies remotely and |
| | supply the result to an OIC Server which allows or denies a |
| | pending access request. |
| ACL Provisioning | A name and resource type (oic.sec.aps) (given to an OIC device |
| Service | that is authorized to provision ACL resources. |
| Action | A sequence of commands intended for OIC servers |
| Bootstrap Service | An OIC device that implements a service of type oic.sec.bss |
| OIC Client | OIC stack instance and application. Typically, the OIC Client |
| | performs actions involving resources hosted by OIC Servers. |
| Credential | A name and resource type (oic.sec.cps) given to an OIC device |
| Provisioning | that is authorized to provision credential resources. |
| Service | |
| Device | An instance of an OIC stack. Multiple stack instances may exist on |
| | the same platform. |
| Device Class | RFC 7228 defines classes of constrained devices that |
| | distinguishes when the OIC small footprint stack is used vs. a |
| | large footprint stack. Class 2 and below is for small footprint |
| | stacks. |
| Entity | An element of the physical world that is exposed through an OIC Device |
| DeviceID | OIC stack instance identifier. |
| Device On-boarding | A utility for introducing a device to a network. |
| Tool | |
| Interface | Interfaces define expected parameters to GET, PUT, POST, |
| | DELETE commands for specific resources |
| Intermediary | A device that implements both client and server roles and may |
| | perform protocol translation, virtual device to physical device |
| | mapping or resource translation. |
| PlatformID | Uniquely identifies the platform consisting of hardware, firmware |
| | and operating system. A platform may host multiple OIC Devices. |
| Property | A named data element within a resource. May refer to intrinsic |
| | properties that are common across all OIC resources. |
| Resource | A data structure that defines the properties, type and interfaces of |
| | an OIC Device. |
| Role (network | Stereotyped behavior of an OIC device; one of [Client, Server or |
| context) | Intermediary] |
| Role (Security | A property of an OIC credential resource that names a role that a |
| context) | device may assert when attempting access to device resources. |
| | Access policies may differ for OIC Client if access is attempted |
| | through a role vs. the device UUID. This document assumes the |
| | security context unless otherwise stated. |
| OIC Server | An OIC resource host. |
| Secure Resource | A module in the OIC Core that implements security functionality |
| Manager | that includes management of security resources such as ACLs, |
| | credentials and device owner transfer state. |
| System | An application used by a network owner to manage an OIC |
| Management Tool | network of devices including on boarding and device lifecycle. |
| Sacl | A signed ACL resource that is dynamically supplied to an OIC |
| | Server |

TABLE 2
Symbols and Abbreviations

| Symbol | Description |
|---|---|
| ACL | Access control list |
| AMS | Access manager service |
| APS | ACL provisioning service |
| BSS | Bootstrap service |
| CPS | Credential provisioning service |
| CRUDN | Create, Read, Update, Delete, Notify |
| DOT | Device On-boarding Tool |
| SMT | System Management Tool |
| SRM | Secure Resource Manager |

FIG. A provides OIC interactions. OIC devices may implement OIC Client role that performs Actions on OIC Servers. Actions access Resources managed by OIC Servers. The OIC stack enforces access policies on resources. End-to-end device interaction can be protected using session protection protocol (e.g. DTLS) or with data encryption methods.

The Security specification may use RAML as a specification language and JSON Schemas as payload definitions for all CRUDN actions. The mapping of the CRUDN actions is specified in the OIC Core Specification.

4.4 Document Sections

This document addresses three security topics; security provisioning (Section 7), secure communications (Section 8) and access control (Section 9). Section 5 describes OIC resources that have security significance and defines security resource architecture. Section 6 describes security considerations related resource discovery and proper use of OIC capabilities.

FIG. B provides OIC framework layers (large device). The OIC security objective aims to define and enforce end-to-end security semantics. This is largely achieved by applying security at the OIC Resource Layer. Security resources define access control policy and house security credentials used to establish end-to-end protections. The security layer within the OIC Resource layer defines the security endpoint for purposes of end-to-end security. Protection of security resources (credentials, ACLs, secure sessions and security configurations etc. . . . ) may be considered by product engineers to best determine how endpoint hardening is achieved.

5.1 Endpoint Protection Philosophy (Informative)

Endpoint protection philosophy can be considered at four scoping levels; (1) group, (2) device, (3) resource and (4) property scope.

Group Level Access—Group scope means access control, authentication and data protection are applied to the group of devices. Group credentials may be used when encrypting data to the group. Group members may authenticate as a member of a group to external entities using shared or privacy preserving credentials. Member devices may be trusted to a minimum standard defined by the group. End-to-end data protection semantics ensures group members have shared access to group data but non-group members are granted explicit access.

Device Level Access—Device scope means access control, authentication and data protection are applied to device endpoints. The device endpoint may contain multiple OIC Resources. Device level access implies accessibility extends to all resources available to the device. End-to-end protection means the device instance identified by its OIC DeviceID is the endpoint. The semantics of pairwise credentials asserts that if a device-A knows a paired device-B shares a pairwise key, only devices A and B share that key. Use of a pairwise key can be used by device-A to authenticate device-B by asserting that if the authentication challenge was not created by device-A, then only device-B could have supplied the challenge. Pairwise keys can be used to establish secure communication between devices A and B that protect data integrity and confidentiality. Pairwise keys may protect DTLS sessions or to encrypt messages and resources using a data marshaling technique such as JSON Web Encryption (JWE) and JSON Web Signatures (JWS).

Resource Level Access—Resource level scope means access is controlled on a per OIC Resource basis. Resource access requires an Access Control List (ACL) that specifies the device resource(s) that may be accessed by a remote subject. The ACL contains the permission set that will be applied for a given resource requestor. Permissions consist of a combination of Create, Read, Update, Delete and Notify (CRUDN) actions. Requestors authenticate as either a device or a device operating with a particular role. OIC devices may acquire elevated access permissions when asserting a role. For example, an ADMINISTRATOR role might expose additional resources and interfaces not normally accessible.

Property Level Access—Property level scope means access is controlled on a per property basis. Resources normally consist of one or more properties. Since different properties achieve different objectives each may require different permissions. Property level access control is achieved by creating a Collection resource that references other resources containing a single property. This technique allows the resource level access control mechanisms to be used to enforce property level granularity.

5.2 Security Provisioning (Informative)

Provisioning of security resources is accomplished with minimal dependence on external layers for security. The provisioning approach is designed to follow a device lifecycle that begins with an on-boarding process that includes device ownership establishment followed by configuration of a bootstrap service. The bootstrap service provisions OIC security resources. Security resources may include additional services for doing key management, access management, device update or other security services yet to be defined.

Devices are aware of their security provisioning status. Self-awareness allows them to be proactive about provisioning or re-provisioning security resources as needed to achieve the devices operational goals. (See Figure J, Figure K).

5.3 Security Theory of Operation (Informative)

Security is applied within the OIC stack instance at the ‘device’ level where end-to-end protection mechanisms apply authentication, confidentiality and integrity. Access to device resources may be controlled with finer granularity within the context of the end-to-end protection mechanism such as DTLS. The security theory of operation is described in the following three steps.

FIG. C provides steps an OIC client takes to access an OIC server's resources.

Step-1—The OIC Client establishes a network connection to the OIC Server. The connectivity abstraction layer ensures the devices are able to connect despite differences in connectivity options. The OIC DeviceID disambiguates the device endpoint. Network addresses map to DeviceIDs. Network address is used to establish connectivity, but security policy is expressed in terms of DeviceID. There may be a binding between the device context and the platform implementing the device. The platform may provide device isolation and execution environment hardening that prevents a rogue device from masquerading as a legitimate device. Platform hardening and device isolation mechanisms may be assessed at device on-boarding and through attestation protocols subsequent to device on-boarding.

Step-2—The second step establishes a secure end-to-end channel that protects the exchange of OIC messages and resources passed between devices. End-to-end encryption keys are stored in the local platform using the best available key storage technique. Keys are obtained from the key key store using a key handle kept in the OIC credential resource. Each OIC device uses encryption keys to securely exchange resource information. The set of devices the OIC Server is able to communicate with securely is contained in the OIC services resource.

Every OIC application uses resources that are referenced by an OIC Server ACL resource. The ACL describes resource level access rights. The ACL is itself an OIC resource. ACLs can specify access permissions for other ACL resources. ACL resources also specify an owner service that does not require an ACL verification check. This avoids ACL provisioning circularity. ACLs can match multiple resources for a given subject (aka device or role). There is a wild card syntax that matches multiple resources at once.

An OIC Client is authenticated as part of step 2 secure session establishment. The ACL entry is matched when the credential used identifies the subject in an ACL resource. There is a wild card ACL subject that allows anonymous requestors. Anonymous subjects supports semantics where the resource being accessed is available to all devices and services. Requestors may assert a role when performing an action requiring privileged access.

Step 3—The final step applies the ACL permission to the requested resource where the decision to allow or deny access is enforced by the OIC Server's Secure Resource manager (SRM).

FIG. D provides secure resource manager (SRM) as the OIC device enforcement point. The Secure Resource Manager (SRM) is the security enforcement point within an OIC Server.

The OIC access control theory of operation requires the requesting device satisfy the security requirements before accessing application resource(s). This is achieved by establishing a connection using well-known port addresses, one for unsecure traffic and another for secured traffic. An OIC Client knows when to select the secure or unsecure port by inspecting resource introspection results. Introspection indicates whether the resource requires device authentication as a prerequisite to access.

Device authentication requirements drive credential-provisioning tasks that occur when a device is on-boarded into the network. A device management utility determines which devices interact with which other devices then determines which security resources are needed. Provisioning security resources is an important prerequisite to normal operation. Subsequent to device provisioning the services resource in the OIC Server will contain credentials appropriate for establishing a secure connection with the OIC Client. Credential resource can support a variety of credentials that authenticates the client and establishes session keys for encryption and integrity protection.

User authentication is not explicitly required by OIC security. Users are authenticated by the OIC aware application. OIC applications associate OIC devices with users. If a specific user is authorized to perform specific operations embodied in an OIC Client, the application developer will configure OIC Clients according to the needs of each user.

OIC ACL policies are expressed at the resource level of granularity. Resources consist of one or more properties that may under certain circumstances require different access than a second property belonging to the same resource. In this circumstance, the resource designer may divide the resource into a collection resource that references the child resources.

FIG. E provides example resource definition with opaque properties. An example resource schema shows the definition of and “oic.thing” resource with two properties: Property-1 and Property-2. Since OIC framework treats property level detail as opaque, it is not possible to author an ACL policy that assigns read-only access to Property-1 and write-only access to Property-2.

FIG. F provides example resource definition with property-level access control using resource ACLs with read access for the first property and write access for the second. Property level access control can be applied when the resource definition is restricted as an OIC Collection where a new resource “oic.RsrcProp-1” is defined having a single property, “Property-1”. A second new resource “oic.RsrcProp-2” contains a single property “Property-2”. Although Property-1 and Property-2 remain opaque to the OIC framework, property level access can be applied using the resource-level ACLs.

The collection resource itself may have an ACL. However, the permissions granted to the collection resource mayn't be applied to any of the resources named in the collection. Every resource that requires an ACL constraint is explicitly named by the ACL resource.

Note that batch interface semantics when applied to a collection resource may allow privilege escalation. The requestor authenticates to the collection's ACL, but the batch action is applied to the devices referenced by the collection. The referenced devices have their own credentials that may differ from that of the original requestor. The referenced devices' credentials may have been granted greater (or lesser) privilege than the original requestor resulting in privilege escalation (or insufficient privilege to complete the operation). Privilege escalation is desirable when it is inappropriate for the original requestor to access the collection resources directly or to assign a special role to the original requestor.

FIG. G provides OIC security resources. The following resources have security relevance:
/oic/sec/acl—local access control list
/oic/sec/amacl—dynamically obtains an access control list using an access manager service
/oic/sec/sacl—signed ACL issued by an access manager service
/oic/sec/cred—credential resource
/oic/sec/svc—services requiring secure connections
/oic/sec/pstat—provisioning status of security resources
/oic/sec/doxm—device owner transfer methods resource

ACL apply to all resources except the /oic/sec/acl resource that refers to it's self. ACL resources have a network management tool that is authorized to update the ACL resource. Nevertheless, it is allowable for an ACL resource to control access to another ACL resource; or any other security resource.

The /oic/sec/svc resources and /oic/sec/cred resources can be created and updated by a resource owner. Hence, there isn't a dependency on an ACL provisioning step as a pre-requisite to provisioning these resources.

Security resources have intrinsic limitations that cannot be overridden by ACL policies. For example the /oic/sec/cred resource contains PrivateData property that is not readable or writable. The Owner is the only entity other than the device itself that can access this property.

6 Security Capabilities and Discovery (Informative)

Discovery of security relevant resources follows OIC core resource discovery conventions. Security resource may contain sensitive content for a given deployment.

This specification does not attempt to determine whether fields have privacy implications within the owned network context. End-to-end protection (e.g. DTLS) may be used to ensure sensitive content is not disclosed to non-owned entities.

Credential resources containing sensitive values are not exposed in the clear in response to discovery and introspection requests. Encrypted sensitive values in credential resources may be exposed outside of an OIC stack instance. Cryptographic keys, passwords, PINs are examples of sensitive values. All other fields may be privacy sensitive values. However, ACL resources are not intended as a privacy protection mechanism.

TABLE 3
Intrinsic Limitations To Resource Property Access

| | Implicit Access | |
|---|---|---|
| | (These entities may override | Explicit Access |
| | explicit access rights for the | (These entities can be given explicit |
| Permission | specified permission) | access rights) |
| — | OIC framework may override | Owner -a resource owner, assigned |
| | access for the local resource. | to the resource during resource |
| | Device management tool may | provisioning can override this |
| | override access during a device | permission. |
| | owner transfer/initial provisioning. | |
| C | OIC framework | Owner |
| | Device management tool. | ACL - Access is further constrained |
| | PUT, POST methods | by an ACL entry. |
| R | OIC framework | Owner |
| | Device management tool | ACL |
| | GET, OBSERVE methods | |
| U | OIC framework | Owner |
| | Device management tool | ACL |
| | PUT, POST methods | |
| D | OIC framework | Owner |
| | Device management tool | ACL |
| | DELETE method | |
| N | OIC framework | Owner |
| | Device management tool | ACL |
| | NOTIFY methods | |

7 Security Provisioning

7.1 Overview (Informative)

During the provisioning phase the target device is being configured with credentials to be used for authorized subjects and access level permissions (Access Control Lists) that defines who is allowed to do what for a given resource.

This section defines the provisioning requirements for the OIC stack including the high level flow required to complete the bootstrapping.

The term on-boarding refers to a process through which a device is introduced into the owner's environment. As part of overall on-boarding, there may be the need to securely transfer device ownership from a previous owner or manufacturer to the intended owner. Owner transfer can be a point of attack since it may be difficult to detect this attack subsequently. Techniques for secure ownership transfer are important for understanding and managing security risks throughout the lifetime of the IoT network. There may be many owner transfer techniques with a wide range of security properties. Device manufacturers may make challenging trade-off decisions that balance security needs with other product requirements. The OIC specification allows for manufacturer specific mechanisms for transferring device ownership called ‘out-of-band transfer of ownership’. The OIC specification defines an interoperable ‘just-works transfer of ownership’ method.

OIC defines the format of a pre-shared key established when the new device is introduced into an owner's network called the “OwnerPSK”. The OwnerPSK is the result of an out-of-band transfer of ownership method between the previous owner/manufacturer and the new owner. Both the OOB and Just-Works methods produce a pre-shared key value that is used to assert device ownership. The OwnerPSK is used to generate the symmetric keys that are used for other purposes. For example, a pair-wise PSK is used to protect device-provisioning data from a system management tool.

Figure H shows a hypothetical system management tool that includes an on-boarding tool. It also shows several other tools that might be useful for provisioning an IoT system. The tool may consist of several disparate or combined tools; a Device On-boarding Tool (DOT), System Authoring Tool (SAT) and a Bootstrap and Provisioning Tool (BPT). The DOT establishes which physical devices are owned by the system and are available to the system object model. The SAT provides a user interface for designing various interaction semantics between devices. The BPT establishes a connection with each device needing provisioning by discovering devices in need of provisioning. Alternatively, devices can track their provisioning status and seek provisioning of a BPT service. When a connection is established, the OwnerPSK may be used to establish a secure connection. The BPT may provision security relevant resources at that time, including ACLs, credentials and other configuration data.

Security resource provisioning follows device “on-boarding”. Device provisioning objectives enable new devices to interact with existing devices securely. This involves establishing security credentials that are used to authenticate each device with every other device with which it needs to interact. Credentials contain the keys used to establish a secure communication channel and to evaluate access rights.

A hierarchy of keys is envisaged that follows a network provisioning strategy that ascribes broadly impactful, but seldom used keys to the root of the hierarchy. Keys with narrower impact that may be used more frequently are ascribed to the leaves of the hierarchy, as shown in Table 4.

TABLE 4

| Key | Instances | Function |
|---|---|---|
| Owner PSK | 1 per device per owner | Take Ownership |
| Bootstrap | 1 per device per | Configure network services |
| Server key | device deployment | |
| Security | 1-3 per device | Provision credentials, ACLs and |
| Provisioning | | |
| Services keys | | other security objects |
| Pair-wise keys | 1 per device-device | Autonomous device-device |
| | pairing | interactions |
| Temporal keys | 1 per session | Semi-autonomous and ad-hoc |
| | | device-device interactions |

OIC devices maintain provisioning status so that provisioning tasks may be performed by multiple services and may resume following system reset or other interruption. Devices may take a proactive role in finding the provisioning service that satisfies the type of provisioning needed. For example, if an OIC Client request fails due to lack of a suitable ACL entry. The OIC Server may request ACL provisioning of its ACL provisioning service. Provisioning is discussed in more detail in Section 7.3. ACL handling is discussed in Section 9.

A secure connection (e.g. DTLS) is used whenever provisioning is attempted to minimize risk of successful attack on the services that define and instantiate the system. Security credentials are used to authenticate OIC devices whether acting in the capacity of client, server or intermediary and to integrity and confidentiality protect device interactions.

Credential provisioning is an important first step following device on-boarding. Among the first credentials provisioned are for services used to further the provisioning activity. Provisioning services use credentials having pre-shared keys that are in turn used to secure the communication channel over which additional provisioning activities may continue.

Cryptographic keys have a lifetime. It may be necessary to refresh cryptographic keys before their lifetime is reached. OIC architecture supports two forms of key refresh mechanism:
1) Key re-provisioning using a credential provisioning service
2) Use of the pair-wise pre-shared key (PSK) with Diffie-Helllman key agreement to produce a new PSK.

If a device is compromised, lost or stolen, credential re-provisioning is needed to remove the credentials that refer to the device. If the device is recovered and found to be trusted for re-use, the device may be reset to manufacturer defaults and device ownership may be re-asserted.

7.2 Device Ownership (Informative)

Device on-boarding may include a method whereby the device owner establishes device ownership. A network management tool may be used to performing device ownership transfer operations. This procedure may be proprietary. This specification anticipates both proprietary and OIC standard device owner transfer methods will be used.

7.2.1 Existing Device Ownership Transfer Approaches (Informative)

There are multiple ways in which manufacturers transfer device ownership to the customer. The table below identifies several approaches. If a vendor-specific method is used, a pre-shared key is the result so that it may be used with OIC security resources and protocols.

Device ownership methods have different security, usability and convenience trade-offs. The right method may be unique to the product and the owner's security expectations. In each case however, the end result is the device contains an owner credential.

TABLE 5
Common methods for transferring device ownership

| Approach | Description | Security Considerations |
|---|---|---|
| Just-Works | Mfg encodes a well-known pairing value | The attacker can be the first person to |
| | such as all zeros. | respond to a owner transfer event then |
| | | spoof the legitimate new owner. |
| Mode Switch | Mfg supplies a switch or button that the | If the attacker comes into physical |
| | user activates to enable functions for | proximity of the device, it is at risk of |
| | taking ownership | being spoofed. |
| Random Device | Device generates a random value that | The attacker can be the first person to |
| PIN | is displayed to a user, User enters the | respond to the owner transfer event |
| | value via a remote device. The first | within the window of time in which the |
| | device to successfully supply the PIN is | PIN is valid. The attacker can then spoof |
| | the new owner. | the legitimate new owner. |
| Pre-provisioned | The manufacturer injects a PIN into the | The attacker obtains the PIN take |
| Device PIN | device ROM at manufacturing time. The | ownership then install attack SW/FW on |
| | PIN is given to the new owner over an | the device. Attacker may allow real owner |
| | out of band channel. (e.g. printed with | to take ownership then reset the device |
| | device packaging). | to re-take ownership. |
| Pre-provisioned | The manufacturer injects a strong | Attacker injects attack keys during |
| strong credential | cryptographic key into the device and | manufacture process and spoof new |
| | distributes the key to the new owner. | owner when device is delivered. |

7.2.2 Vendor-Specific Owner Establishment (Informative)

The OwnerPSK is a pre-shared key that is the product of an ownership transfer method. Table 5, shows classes of these methods. A pre-shared key called the “OwnerPSK” is the result of a device owner transfer method (DOXM). The following paragraph outlines an approach for constructing OwnerPSK given possible available input values.

The OwnerPSK generation method is informative only. Guidelines are provided for convenience purposes only:

OwnerPSK=PRF(Random, DeviceLabel, NewOwnerLabel, PreviousOwnerLabel);

Where: PRF is a pseudo-random function used for key generation that cryptographically combines function parameters such that it exhibits pre-image resistance, collision resistance and second pre-image resistance.

Random is a random value with sufficient entropy,

DeviceLabel identifies the device, whose ownership is being transferred,

NewOwnerLabel is a value supplied by the new owner acknowledging the intent to become the new owner. If the platform contains a platform ownership capability such that multiple OIC device instances hosted on the same platform would not require taking ownership subsequent to the first OIC device instance. The NewOwnerLabel may identify the platform ownership method and may reference the platform owner authorization data. The NewOwnerLabel values may be shared between OIC Device and owner transfer service to facilitate OwnerPSK computation using the prf( ).

PreviousOwnerLabel is a value supplied by the previous owner acknowledging the intent to transfer ownership to the new owner.

7.2.3 OwnerPSK Format (Normative)

The OwnerPSK value may have the following format:

| Name | Value | Type | Description |
|---|---|---|---|
| Length | 16 | OCTET | Specifies the number of 8-bit octets |
| | | | following Length |
| Key | opaque | OCTET | 16 byte array of octets. When used as input |
| | | Array | to a PSK function Length is omitted. |

| Name | Value | Type | Description |
|---|---|---|---|
| Length | 32 | OCTET | Specifies the number of 8-bit octets |
| | | | following Length |
| Key | opaque | OCTET | 32 byte array of octets. When used as input |
| | | Array | to a PSK function Length is omitted. |

7.2.4 OIC Just-Works Device Owner Transfer Method (Normative)

Compliant OIC devices may implement the just-works owner transfer method as shown in FIG. I to ensure interoperability. This method relies on an anonymous Diffie-Hellman key agreement protocol to arrive at symmetric keys that are input to the OwnerPSK calculation.

Supported ciphersuites:
TLS_ECDH_ANON_WITH_AES_128_CBC_SHA,
TLS_ECDH_ANON_WITH_AES_256_CBC_SHA,
TLS_ECDH_ANON_WITH_AES_128_CBCSHA256,
TLS_ECDH_ANON_WITH_AES_256_CBC_SHA256,

Note: Device classes are defined in RFC 7228 and RFC 6655.

All OIC devices may implement:
TLS_ECDH_ANON_WITH_AES_128_CBC_SHA.

Class-2 and lower devices MAY implement:
TLS_ECDH_ANON_WITH_AES_128_CBC_SHA256,
TLS_ECDH_ANON_WITH_AES_256_CBC_SHA,
TLS_ECDH_ANON_WITH_AES_256 CBC_SHA256

Devices above Class-2 may implement:
TLS_ECDH_ANON_WITH_AES_128_CBC_SHA256,
TLS_ECDH_ANON_WITH_AES_256_CBC_SHA,TLS_ECDH_ANON_WITH_AES_256_CBC_SHA256

The OwnerPSK calculation may follow the following format to ensure interoperability across different vendor products:
OwnerPSK=PRF(MasterSecret, Message, Length);

Where:
PRF may use TLS PRF defined by RFC5246.
MasterSecret is the master secret key resulting from the DTLS handshake
Message is a concatenation of the following:
DoxmType string for the just works method (e.g. “oic.sec.doxm.jw”)
OwnerID is a URI identifying the device owner identifier and the device that maintains OwnerPSK.
   DeviceID is new device's DeviceID (e.g. “urn:uuid:XXXX-XXXX-XXXX-XXXX”).
   Length is the length of Message in octets

7.2.5 OIC Out-of-Band PIN Device Owner Transfer Method (Normative)

The PIN-based device owner transfer method as shown in FIG. J uses a pseudo-random function (PBKDF2) defined by RFC2898 and a PIN exchanged via an out-of-band method (which is outside the scope this specification) to generate a pre-shared key. The PIN-authenticated pre-shared key (PPSK) is supplied to a TLS ciphersuite that accepts a PSK.

PPSK=PBKDF2(PRF, PIN, DeviceID, c, dkLen)

The PBKDF2 function has the following parameters:
PRF—Uses the DTLS PRF.
PIN—obtain via out-of-band channel.
DeviceID—UUID of the new device.
c—Iteration count initialized to 1000, incremented upon each use.
dkLen—Desired length of the derived PSK in octets.

The PPSK is supplied to one of the following TLS ciphersuites:
TLS_ECDHE_PSK_WITH_AES_128_CBC_SHA, (* 16 octet integrity check *)
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_128_CCM_8, (* 8 octet integrity check *)
TLS_PSK_DHE_WITH_AES_256_CCM_8,
TLS_DHE_PSK_WITH_AES_128_CCM,
TLS_DHE_PSK_WITH_AES_256_CCM

See RFC4279, RFC5489 and RFC6655.

All OIC devices may implement:
TLS_ECDHE_PSK_WITH_AES_128_CBC_SHA,
TLS_PSK_DHE_WITH_AES_128_CCM_8,

Class-2 and lower devices may implement:
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_256_CCM_8,
TLS_DHE_PSK_WITH_AES_128_CCM,
TLS_DHE_PSK_WITH_AES_256_CCM

Devices above Class-2 may implement:
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_256_CCM_8,
TLS_DHE_PSK_WITH_AES_128_CCM, TLS_DHE_PSK_WITH_AES_256_CCM

The OwnerPSK calculation is the same as defined for the oic.sec.doxm.jw method (see section 7.2.3).

7.2.6 Device Owner Transfer Methods and State (Normative)

The /oic/sec/doxm resource contains the set of supported device owner transfer methods.

Security resource are discoverable through the /oic/res resource. Resource discovery processing respects the CRUDN constraints supplied as part of the security resource definitions contained in this specification.

TABLE 6
Owner Transfer Method resource definition

| | | Resource Type | | | Related |
|---|---|---|---|---|---|
| | Resource Type | ID (“rt” | | | Functional |
| Fixed URI | Title | value) | Interfaces | Description | Interaction |
| /oic/sec/doxm | Device Owner | urn:oic.sec.doxm | | Resource for supporting | Configuration |
| | Transfer Methods | | | device owner transfer | |

TABLE 7
Owner Transfer Method Properties definition

| | | | | | | | | |
|---|---|---|---|---|---|---|---|---|
| Property | Property | Value | Value | | Access | | | |
| Title | Name | Type | Rule | Unit | Mode | Mandatory | Instance | Description |

| | | | | | | | |
|---|---|---|---|---|---|---|---|
| Owner | Oxm | OxmType | — | R | Yes | Multiple | URN identifying |
| Transfer | | | | | | | the organization |
| Method | | | | | | | defining the |
| | | | | | | | owner transfer |
| | | | | | | | method and the |
| | | | | | | | method name. |
| Oxm | OxmSel | OxmType | — | R | Yes | Single | The Oxm that |
| Selection | | | | | | | was selected for |
| | | | | | | | device |
| | | | | | | | ownership |
| | | | | | | | transfer. |
| Owned | Owned | Boolean | T\|F | R | Yes | Single | Indicates |
| | | | | | | | whether or not |
| | | | | | | | the device |
| | | | | | | | ownership has |
| | | | | | | | been |
| | | | | | | | established. |
| | | | | | | | FALSE indicates |
| | | | | | | | device is |
| | | | | | | | unowned. |
| DeviceID | DidFormat | UINT8 | 0-255 | R | Yes | Single | Enumerated |
| Format | | | | | | | device ID |
| | | | | | | | format. |
| | | | | | | | [0 = URN] (e.g. |
| | | | | | | | urn:uuid:XXXX- |
| | | | | | | | XXXX-XXXX-XXXX) |
| DeviceID | DeviceID | OCTET | — | R | Yes | Single | DeviceID |
| | | [ ] | | | | | assigned to this |
| | | | | | | | instance of the |
| | | | | | | | OIC framework. |
| | | | | | | | DidFormat |
| | | | | | | | determines how |
| | | | | | | | to interpret the |
| | | | | | | | OCTET string |
| Device | DevOwner | oic.sec.svc | — | R | Yes | Single | URI identifying a |
| Owner | | | | | | | service that is |
| | | | | | | | the device |
| | | | | | | | owner. This may |
| | | | | | | | be any value |
| | | | | | | | chosen by the |
| | | | | | | | device owner. |
| Resource | Rowner | oic.sec.svc | — | R | Yes | Single | This resource's |
| Owner | | | | | | | owner. Typically |
| | | | | | | | this is the |
| | | | | | | | bootstrap |
| | | | | | | | service that |
| | | | | | | | instantiated this |
| | | | | | | | resource |

The owner transfer method resource contains an ordered list of owner transfer methods where the first entry in the list is the highest priority method and the last entry the lowest priority.

The device manufacturer configures this resource with the most desirable (most secure) methods with high priority and least desirable with low priority. The network management tool queries this list at the time of on boarding when the network management tool selects the most appropriate method.

Subsequent to an owner transfer method being chosen the agreed upon method may be entered into the/doxm resource using the OxmSel property.

Owner transfer methods consist of two parts, a URN identifying the vendor or organization and the specific method.

<OxmType> ::= ″urn:″ <NID> ″:″ <NSS>
<NID> :: = <Vendor-Organization>
<NSS> ::= <Method> | {<NameSpaceQualifier> “.”} <Method>
<NameSpaceQualifier> ::= String
<Method> ::= String
<Vendor-Organization> ::= String

When an owner transfer method successfully completes, the Owned property is set to ‘1’ (TRUE). Consequently, subsequent attempts to take ownership of the device will fail.

The Secure Resource Manager (SRM) generates a device identifier (DeviceID) that is stored in the /oic/sec/doxm resource in response to successful ownership transfer.

Owner transfer methods may communicate the DeviceID to the service that is taking ownership. The service may associate the DeviceID with the OwnerPSK in a secured database.

Once owned, the bootstrap service (oic.sec.bss) may change the owned state to ‘0’ (FALSE).

TABLE 8
OIC defined owner transfer methods

| Value Type | | Enumeration | |
|---|---|---|---|
| Name | Value Type URN | Value | Description |
| OICJustWorks | urn:oic:oic.sec.doxm.jw | 0 | The just-works method relies on anonymous |
| | | | Diffie-Hellman exchange to realize a shared |
| | | | secret. It is subject to man-in-the-middle |
| | | | threats. |
| OICSharedPin | urn:oic:oic.sec.doxm.pin | 1 | The shared PIN method relies on an out-of- |
| | | | band PIN distribution method to generate a |
| | | | shared secret that mitigates many man-in- |
| | | | the-middle threats. |

7.3 Provisioning (Informative)

OIC security provisioning anticipates network deployments having multiple specialized services.
Bootstrap service implements device owner transfer protocols
Credential provisioning service implements key management protocols
Access control policy provisioning service implements ACL provisioning
Access management service implements authorization services

New service types may be added in the future.

Services deployment may combine all services into a single server or multiple servers may cooperate to specialize.

7.3.1 Provisioning a Bootstrap Service

The bootstrap service credential is provisioned to a device as part of applying the device owner transfer method. This credential may be used subsequently to discover and establish a secure connection to a bootstrap service.

The oic.sec.bss creates or updates the oic.sec.svc resources for credential provisioning service, ACL provisioning service and potentially other services. The oic.sec.svc resource contains a list of services the device may consult for self-provisioning. The oic.sec.bss entry identifies the bootstrap service. The oic.sec.bss service may use a pre-shared key to establish a secure connection with a device. The oic.sec.cred resource is provisioned with the PSK by a mediator or the PSK may be dynamically established using a Diffie-Hellman exchange. See Section 8.3 for details related to Diffie-Hellman PSK generation. If the oic.sec.bss service is provisioned by a network administration tool, the PSK may be derived using the OwnerPSK as the PSK input to a TLS ciphersuite that accepts a PSK parameter.

After the oic.sec.bss PSK is established, it may be used to refresh the bootstrap server PSK following the approach defined in Section 8.3.

7.3.2 Provisioning Other Services

Other servers may specialize in the type of provisioning that is performed. Each device may posses an oic.sec.svc resource that describes which service entity to select for provisioning support. A single server may host multiple provisioning services. This flexibility allows localized as well as centralized functions.

A bootstrap service may be used to provision other services. The bootstrap service may initiate service provisioning by triggering the device to re-provision its credential resources. The device instantiates oic.sec.svc and oic.sec.cred resources for each provisioning service with which the device may need to interact.

A bootstrap service may provision credentials for support services of the following type:
oic.sec.cps
oic.sec.aps
oic.sec.ams

The bootstrap service provisions the appropriate keys to allow provisioning service and OIC device to establish a secure session. Subsequent to bootstrap provisioning, the support service's credential resource will contain a key that a corresponding OIC Device credential resource can verify; and vise versa.

OIC Server devices may restrict the type of key (CredType) supported. OIC Client devices may support all CredTypes (see Table 14) to facilitate interoperability.

7.3.3 Credential Provisioning

OIC clients and servers may be configured for secure interactions for both pairwise and group semantics. Several types of credential are supported by a /oic/sec/cred resource. They include at least the following key types; pairwise symmetric keys, group symmetric keys, asymmetric keys and signed asymmetric keys. Keys may be provisioned by a credential provisioning service (e.g. “oic.sec.cps”) or dynamically using a Diffie-Hellman key agreement protocol.

See Figure L for example credential provisioning flows and Section 8.3 for Diffie-Hellman based key agreement.

7.3.3.1 CPS Mediated Credential Provisioning

Device-device interaction requires each device to seek credential provisioning. A device may discover the need to update credentials if a secure connection attempt fails. The device requests credential update by establishing a secure connection to a credential provisioning service. The device may enter credential-provisioning mode (e.g. /oic/sec/psta.Cm=16) and may configure operational mode (e.g. /oic/sec/pstat.Om=“1”). The device requests an update to its credential resource. The CPS responds with a new pairwise pre-shared key (PSK). The CPS may wait for a request from the second device or may initiate a provisioning operation with the second device to complete the provisioning. A device causes the target device to seek provisioning by sending it a /oic/sec/cred resource that identifies the needed credential. Since the credential PSK is assigned by a CPS, it is omitted from the “PrivateData” property.

The credential provisioning service may initiate credential provisioning with the devices that have the /oic/sec/pstat.Om configured for provisioning by a provisioning server.

The device may remain in credential update mode until the expected credential is successfully updated.

Figure K is a CPS mediated credential provisioning.

7.3.3.2 Symmetric Pairwise-Key Credential Establishment

Some conditions favor device-to-device credential creation. Such circumstances include:
When a CPS is not available due to connectivity limitation
When devices dynamically connect over wireless PAN
When devices from different networks connect in ad-hoc fashion

Figure L is a device-to-device negotiation of pairwise credentials.

7.3.3.3 Role Assignment

OIC Clients can operate with roles such as ‘Administrator’ or ‘Zone 1’ etc. . . . . Roles are defined by the credential provisioning service (e.g. rt=“oic.sec.cps” or by a network administration tool. Roles are properties in a credential resource. OIC servers enforce role constraints using ACLs.

OIC client devices seeking role provisioning may want to enter (exit) the /oic/sec/pstat modes for credential and ACL provisioning simultaneously to ensure consistency of access policy before allowing normal operation.

An OIC client asserts which role it is using by including the role string with the CoAP payload, e.g. GET /a/light; ‘role’=admin

7.3.3.4 Asymmetric Key Credentials

The ACL provisioning service (e.g. rt=“oic.sec.aps”) may digitally sign an access control list as part of issuing a /oic/sec/sacl resource. The public key used by OIC Servers to verify the signature is provisioned as part of credential provisioning. A /oic/sec/cred resource with an asymmetric key type or signed asymmetric key type is used. The PublicData property contains the ACL provisioning service's public key.

7.3.4 ACL Provisioning

During ACL provisioning, the device establishes a secure connection to an ACL provisioning service. The ACL provisioning service will instantiate or update device ACLs according to the ACL policy.

The device and ACL provisioning service may establish an observer relationship such that when a change to the ACL policy is detected; the device is notified triggering ACL provisioning.

7.4 Security Service Resource Definition (Normative)

The /oic/sec/svc resource is used to identify the credentials services used for end-to-end secure connectionuseful for performing security configuration.

Services Resource Definition:

TABLE 9
Secure Service resource definition

| | | Resource | | | Related |
|---|---|---|---|---|---|
| | Resource | Type ID | | | Functional |
| Fixed URI | Type Title | (“rt” value) | Interfaces | Description | Interaction |
| /oic/sec/svc | Services | urn:oic.sec.svc | | The services resource | Configuration |
| | | | | contains a list of | |
| | | | | services that are used | |
| | | | | to configure OIC | |
| | | | | devices | |

TABLE 10
Security Service resource properties definition

| Property | Property | Value | Value | | Access | | | |
|---|---|---|---|---|---|---|---|---|
| Title | Name | Type | Rule | Unit | Mode | Mandatory | Instance | Description |
| Server | svcdid | oic.uuid | | — | R | Yes | Single | Identifies the |
| DeviceID | | | | | | | | device OIC uses to |
| | | | | | | | | establish a secure |
| | | | | | | | | connection |
| Service | svct | String | oic.sec.{ServiceType} | | R | Yes | Multiple | Type of service |
| Type | | | | | | | | implemented by |
| | | | | | | | | this OIC server. |
| Supported | sct | oic.sec.credtype | bitmask | | R | Yes | Single | Bitmask specifying |
| Credential | | | | | | | | the supported |
| Types | | | | | | | | security modes |
| Server | cid | UINT16 | 0 - 64K-1 | | R | Yes | Single | Local reference to |
| Credential | | | | | | | | credential used to |
| ID | | | | | | | | authenticate the |
| | | | | | | | | service |
| Client | cid | UINT16 | 0 - 64K-1 | | R | Yes | Single | Local reference to |
| Credential | | | | | | | | credential used to |
| ID | | | | | | | | authenticate this |
| | | | | | | | | device to the |
| | | | | | | | | service |
| Resource | rowner | oic.sec.svc | oic.sec.bss | | R | Yes | Single | Refers to the |
| Owner | | | | | | | | bootstrap service |
| | | | | | | | | resource that |
| | | | | | | | | instantiates/updates |
| | | | | | | | | this resource |

Each secure end-to-end connection may identify the credentials used to authenticate the local device to the remote device and to verify the remote device credentials. The remote device may support a subset of the /oic/sec/cred credential resources, the ‘SupportedCreds’ property may be used to determine which credential resources are appropriate to supply during authentication exchanges.

Security Service Type Definitions:

The table below defines security service types. “{ServiceType}” may be used in this document to refer to an instance of a service type URN.

TABLE 11
Secure Service type definitions

| Type Name | Type URN | Description |
|---|---|---|
| Device Owner | urn:oic.sec.doxm | Service type for onboarding devices into the network |
| Transfer Service | | |
| Bootstrap Service | urn:oic.sec.bss | Service type for a bootstrap service |
| Credential | urn:oic.sec.cps | Service type for a credential provisioning service |
| Provisioning Service | | |
| ACL Provisioning | urn:oic.sec.aps | Service type for an ACL provisioning service |
| Service | | |
| Access Management | urn:oic.sec.ams | Service type for an Access Management service |
| Service | | |
| Other | urn:{ServiceType} | Other service type definition |
| Unspecified | urn:* | Service type is intentionally not specified and satisfies |
| | | any service. |

Devices seeking to establish secure connection to this device may inquire as to which service types are supported and have accompanying credentials. This resource is exposed as part of OIC core resource introspection mechanism.

A device may identify acceptable service types used during normal operation by supplying the service type URN.

The asterisk ‘*’ URN explicitly asserts that a service type designation is not required.

7.5 Provisioning Status Resource (Normative)

The /oic/sec/pstat resource represents a device's provisioning status.

TABLE 12
Provisioning Status resource definition

| | | Resource | | | Related |
|---|---|---|---|---|---|
| | Resource Type | Type ID (“rt” | | | Functional |
| Fixed URI | Title | value) | Interfaces | Description | Interaction |
| /oic/sec/pstat | Provisioning | urn:oic.sec.pstat | | Resource for | Configuration |
| | Status | | | managing | |
| | | | | device | |
| | | | | provisioning | |
| | | | | status | |

TABLE 13
Provisioning Status Properties definition

| Property | Property | Value | Value | | Access | | | |
|---|---|---|---|---|---|---|---|---|
| Title | Name | Type | Rule | Units | Mode | Mandatory | Instance | Description |
| Is | IsOp | Boolean | T\|F | — | R | Yes | Single | Device can function |
| Operational | | | | | | | | even when Cm is non- |
| | | | | | | | | zero. Device will only |
| | | | | | | | | service requests |
| | | | | | | | | related to satisfying |
| | | | | | | | | Tm when IsOp is |
| | | | | | | | | FALSE. |
| Current | Cm | oic.sec.dpm | 0 - 64K-1 | — | RW | Yes | Single | Specifies the current |
| Mode | | | | | | | | device mode. |
| Target | Tm | oic.sec.dpm | 0 - 64K-1 | — | RW | No | Single | Specifies a target |
| Mode | | | | | | | | device mode the |
| | | | | | | | | device is attempting to |
| | | | | | | | | enter. |
| Device | DeviceID | urn:oic.uuid | — | — | R | No | Single | Specifies the device to |
| ID | | | | | | | | which the provisioning |
| | | | | | | | | status applies. If not |
| | | | | | | | | specified, it applies to |
| | | | | | | | | {this} device. |
| Operational | Om | oic.sec.dpom | 0-255 | | RW | Yes | Single | Current provisioning |
| Mode | | | | | | | | services operation |
| | | | | | | | | mode |
| Supported | Sm | oic.sec.dpom | 0-255 | | R | Yes | Multiple | Supported |
| Mode | | | | | | | | provisioning services |
| | | | | | | | | operation modes |
| Commit | Ch | oic.sec.sha256 | 0-UINT256 | — | R | Yes | Single | Sha256 hash value of |
| Hash | | | | | | | | all provisioning |
| | | | | | | | | commands that have |
| | | | | | | | | been committed by |
| | | | | | | | | the device. |

The provisioning status resource /oic/sec/pstat is used to enable OIC devices to perform self-directed provisioning. Devices are aware of their current configuration status and a target configuration objective. When there is a difference between current and target status, the device may consult the /oic/sec/svcs resource to discover whether any suitable provisioning services exist. The OIC device may request provisioning if configured to do so. The /oic/sec/pstat?Om property will specify expected device behavior under these circumstances.

Self-directed provisioning enables devices to function with greater autonomy to minimize dependence on a central provisioning authority that may be a single point of failure in the network.

The device computes a hash of the CoAP POST or PUT command that was successfully applied by the OIC Server. The OIC Server supplies the current CommitHash property when requesting provisioning; the server extends the hash with the POST or PUT command. If the client fails to commit the POST or PUT, the CommitHash property will not reflect the uncommitted command.

Device Provisioning Mode Type Definition:

The provisioning mode type is a 16-bit mask enumerating the various device provisioning modes. “{ProvisioningMode}” may be used in this document to refer to an instance of a provisioning mode without selecting any particular value.

| Type Name | Type URN | Description |
|---|---|---|
| Device | urn:oic.sec.dpm | Device provisioning mode is a |
| Provisioning Mode | | 16-bit bitmask describing |
| | | various provisioning modes |

| Value | Device Mode | Description |
|---|---|---|
| bx0000,0000 (0) | Normal | Device mode for normal operation |
| bx0000,0001 (1) | Reset | Device reset mode enabling manufacturer reset operations |
| bx0000,0010 (2) | Take Owner | Device pairing mode enabling owner transfer operations |
| bx0000,0100 (4) | Bootstrap Service | Bootstrap service provisioning mode enabling instantiation of a |
| | | bootstrap service |
| bx0000,1000 (8) | Security | Service provisioning mode enabling instantiation of device |
| | Managerment | security services and related credentials |
| | Services | |
| bx0001,0000 (16) | Provision | Credential provisioning mode enabling instantiation of pairwise |
| | Credentials | device credentials using a management service of type |
| | | urn:oic.sec.cps |
| bx0010,0000 (32) | Provision ACLs | ACL provisioning mode enabling instantiation of device ACLs |
| | | using a management service of type urn:oic.sec.aps |
| bx0100,0000 (64) | <Reserved> | Reserved for later use |
| bx1000,0000 (128) | <Reserved> | Reserved for later use |

Device Provisioning Mode High-Byte:

| Value | Device Mode | Description |
|---|---|---|
| bx0000,0000-bx1111,1111 | <Reserved> | Reserved for later use |

Device Provisioning Operation Mode Type Definition:

The provisioning operation mode type is a 8-bit mask enumerating the various provisioning operation modes.

| Type Name | Type URN | Description |
|---|---|---|
| Device | urn:oic.sec.dpom | Device provisioning operation mode |
| Provisioning | | is a 8-bit bitmask describing various |
| OperationMode | | provisioning operation modes |

Device Provisioning Operation Mode Bits:

| Value | Operation Mode | Description |
|---|---|---|
| bx0000,0000 (0) | Multiple devices | Provisioning related services are placed in different |
| | have different | devices. Hence, a provisioned device may establish |
| | provisioning | multiple DTLS sessions for each service. This condition |
| | services | exists when bit 0 is FALSE. |
| bx0000,0001 (1) | Single device has | All provisioning related services are in the same |
| | all provisioning | device. Hence, instead of establishing multiple DTLS |
| | services | sessions with provisioning services, a provisioned |
| | | device establishes only one DTLS session with the |
| | | device. This condition exists when bit 0 is TRUE. |
| bx0000,0010 (2) | Provisioning service | Device supports provisioning service control of this |
| | in control of | device's provisioning operations. This condition exists |
| | provisioning | when bit 1 is TRUE. When this bit is FALSE this device |
| | | controls provisioning steps. |
| bx1111,11xx | <Reserved> | Reserved for later use |

7.6 Bootstrap Examples (Informative)

New devices may advertise their existence and need for bootstrapping using OIC core discovery services. The device maintains a provisioning status (e.g. /oic/sec/pstat) resource that establishes which provisioning tasks are needed.

Devices may operate using a self-directed strategy to bootstrap device provisioning. This is achieved when device owner transfer includes configuration of the bootstrap service. Self-directed provisioning may utilize the /oic/sec/pstat resource to manage its progress. The /oic/sec/pstat target mode value informs the bootstrap server which security services may be provisioned as part of bootstrap.

A provisioning client device may discover the new device and determine it is capable of provisioning new device. The provisioning client queries the new device's /oic/sec/pstat value to determine what provisioning actions are available. It then establishes an authenticated session over which the provisioning operations are performed.

The /oic/sec/pstat resource establishes the devices current provisioning level. A mode value of (4) asserts that the device bootstrap service and a mode value of (16) assert credentials are available for provisioning.

TABLE 14
Step describing a provisioning-service-led provisioning of a new device

| Step | Description |
|---|---|
| 1 | Discover devices that are owned and support provisioning-tool-led provisioning. |
| 2 | The /oic/sec/doxm resource identifies the device and it's owned status. |
| 3 | PT obtains the new device's provisioning status found in /oic/sec/pstat resource |
| 4 | The pstat resource describes the types of provisioning modes supported and which is currently |
| | configured. A device manufacturer may set a default current operational mode (Om). If the Om isn't |
| | configured for PT-led provisioning, its Om value can be changed. |
| 5-6 | PT instantiates the /oic/sec/svc resource. The svc resouce includes entries for the bootstrap service, |
| | ACL provisioning service and credential provisioning service. It references credentials that may not |
| | have been provisioned yet. |
| 7-8 | The new device provisioning status mode is updated to reflect that various services have been |
| | configured. |
| 9-10 | PT instantiates the /oic/sec/cred resource. It contains credentials for the provsioned services and |
| | other OIC devices |
| 11-12 | The new device provisioning status mode is updated to reflect that the security services have been |
| | configured. |
| 13-14 | PT instantiates /oic/sec/acl resources. |
| 15 | The new device provisioning status mode is updated to reflect that ACLs have been configured. The PT |
| | computes a hash of all the provisioning messages “CommitHash”. CommtHash is given to the new |
| | device. |
| 16 | The new device compares the CommitHash with an internal CommitHash value it has computed over |
| | the provisioning messages. If these values match, the /oic/sec/pstat. CommitHash property is updated |
| | with the new value. |
| 17 | The return code reflects successful CommitHash verification and resource update. |
| 18 | The secure session is closed. |

Figure M shows provisioning-Service-Led Provisioning of a New Device. Table 15 shows steps for device-led provisioning of a new device using a single provisioning service.

| Step | Description |
|---|---|
| 1 | The new device verifies it is owned. |
| 2 | The new device verifies it is in self-provisoning mode. |
| 3 | The new device verifies its target provisoning state is fully provisioned. |
| 4 | The new device verifies its current provisioning state requires provisioning. |
| 5 | The new device initiates a secure session with the provisioning tool using the |
| | /oic/sec/doxm.DevOwner value to open a TLS connection using OwnerPSK. |
| 6-7 | The new device gets the /oic/sec/svc resources. The svc resource includes entries for the |
| | bootstrap service, ACL provisioning service and credential provisioning service. It references |
| | credentials that may not have been provisioned yet. |
| 8-9 | The new device gets the PT commitHash value. |
| 10 | The new device verifies the PT commitHash value matches its local value. |
| 11 | The new device updates Cm to reflect provisioning of bootstrap and other services. |
| 12-13 | The new devices gets the /oic/sec/cred resources. It contains credentials for the provisioned |
| | services and other OIC devices. |
| 14-15 | The new device gets the PT commitHash value. |
| 16 | The new device verifies the PT commitHash value matches its local value. |
| 17 | The new device updates Cm to reflect provisioning of credential resources. |
| 18-19 | The new device gets the /oic/sec/acl resources. |
| 20-21 | The new device gets the PT commitHash value. |
| 22 | The new device verifies the PT commitHash value matches its local value. |
| 23 | The new device updates Cm to reflect provisioning of ACL resources. |
| 24 | The secure session is closed. |

Table 16 shows step for device-led provisioning of a new device using multiple provisioning services.

| Step | Description |
|---|---|
| 1 | The new device verifies it is owned. |
| 2 | The new device verifies it is in self-provisioning mode. |
| 3 | The new device verifies its target provisioning state is fully provisioned. |
| 4 | The new device verifies its current provisioning state requires provisioning. |
| 5 | The new device initiates a secure session with the provisioning tool using the |
| | /oic/sec/doxm.DevOwner value to open a TLS connection using OwnerPSK. |
| 6-7 | The new device gets the /oic/sec/svc resources. The svc resource includes entries for the |
| | bootstrap service, ACL provisioning service, ACL management service and credential |
| | provisioning service. It references credentials that may not have been provisioned yet. |
| 8-9 | The new devices gets the /oic/sec/cred resources. It contains credentials for the provisioned |
| | services.. |
| 10-11 | The new device gets the PT commitHash value. |
| 12 | The new device verifies the PT commitHash value matches its local value. |
| 13 | The new device updates Cm to reflect provisioning of support services. |
| 14 | The new device closes the DTLS session with the provisioning tool. |
| 15 | The new device finds the credential provisioning service (CPS) from the /oic/sec/svc resource |
| | and opens a DTLS connection. The new device finds the credential to use from the |
| | /oic/sec/cred resource. |
| 16-17 | The new device requests additional credentials that may be needed for interaction with other |
| | devices. |
| 18-19 | The new device gets the CPS commitHash value |
| 20 | The new device verifies the CPS commitHash value matches its local value. |
| 21 | The new device updates Cm to reflect provisioning of credential resources. |
| 22 | The DTLS connection is closed. |
| 23 | The new device finds the ACL provisioning service (APS) from the /oic/sec/svc resource and |
| | opens a DTLS connection. The new device finds the credential to use from the /oic/sec/cred |
| | resource. |
| 24-25 | The new device gets ACL resources that it will use to enforce access to local resources. |
| 26-27 | The new device may also get signed ACL resources immediately or in response to a |
| | subsequent device resource request. |
| 28-29 | The new device may also get a list of resources that may consult an Access Manager for |
| | making the access control decision. |
| 30-31 | The new device gets the APS commitHash value |
| 32 | The new device verifies the APS commitHash value matches its local value. |
| 33 | The new device updates Cm to reflect provisioning of ACL resources. |
| 34 | The DTLS connection is closed. |

Figure N is Device-led provisioning of a new device using a single provisioning service.

Figure O is an Example of a device-led provisioning of a new device with multiple provisioning services.

8 Session Protection with DTLS

DTLS sessions establish end-to-end security between OIC devices. The keys used to establish DTLS sessions are protected within the OIC framework and may use platform features for hardened key storage.

8.1 Unicast Session Semantics (Informative)

This section defines the security requirements applicable over a local IP (v4 or v6) subnet. The authentication protocol to provide E2E security for OIC over local IP is DTLS. The main rationale is that it is designed to function over lossy, connectionless networks.

Securing the communication channel between OIC client and server devices is optional. The discovery (resource introspection) and control/data plane for the resource model is done over CoAP. The OIC stack will support insecure and secure communication over distinct ports. CoAP discover and introspection is always supported on the default UDP port 5683. Secure CoAP (CoAPs) communication uses the default UDP port 5684.

DTLS implementations typically contain both the DTLS protocol implementation as well as support for reassembly/reordering, retransmission and implementation for the crypto related functions such as AES-CCM, HMAC, SHA2 etc. Many of the constrained devices have very limited storage and may already provide same crypto functions required by DTLS.

It is desired that the implementation is modularized with interfaces defined for common crypto functions so that a vendor can plug in and use their own implementation and thereby reducing the resulting code size required by the implementation.

8.1.1 Cipher Suites

The OIC stack relies upon ciphersuites that accept a pre-shared key for device authentication and to ensure interoperability. Generally, constrained devices implement minimal ciphersuite support according to constrained environment limitations, while less constrained devices implement a broad range. The strongest ciphersuite common to a pair of devices will be selected during the cipher suite negotiation—See RFC6655.

8.1.2 Device Authentication

OIC devices can maintain a credential resource containing a pre-shared key that a client device uses to authenticate to a server device and likewise a server device uses to verify the authenticity of the client device. The pre-shared key may also be used to establish a DTLS secure session.

A pair-wise PSK authenticates both devices sharing the PSK. If Device_A initiates a DTLS session using a pair-wise PSK (PSKAB) Device_B locates the service resource (/oic/sec/svc) corresponding to Device_A and PSKAB in the credential resource (/oic/sec/cred) belonging to Device_A. Device_B supplies PSKAB as input to the DTLS ciphersuite. Device_A correspondingly supplies his copy of PSKAB to the ciphersuite. If both sides supply the same PSK then the handshake succeeds.

Since there are only two instances of PSKAB, (one for Device_A and the other Device B), Device_A concludes that the endpoint must be Device_B since Device_B is the only other device that shares this PSK. Device_B arrives at a similar conclusion given Device_A. Hence, both endpoints are authenticated by PSKAB. Both devices verify the device ID contained in the credential resource matches the device ID for the established connection.

Both devices protect PSKAB using device secure storage.

8.1.3 Device Authentication with Role Privilege

If the credential resource used to establish the DTLS session includes role designations, the OIC server responding to client requests will apply the role information to the ACL evaluation logic.

OIC credential resources may include asymmetric keys as authentication credentials. Asymmetric public keys may be signed by a third party in the form of a certificate or may be unsigned. Credential provisioning services introduce devices to one another by creating /oic/sec/cred resources containing unsigned public keys associated with a respective device identifier.

Authentication using asymmetric keys with DTLS requires negotiation of the appropriate ciphersuites. See RFC5246, RFC6367 and RFC7027.

8.2 Device Credential Resource (Normative)

8.2.1 Device Credential Resource Definition

### Table 17 is a Device Credential Resource Definition

| | | Resource | | | Related |
|---|---|---|---|---|---|
| | Resource | Type ID (“rt” | | | Functional |
| Fixed URI | Type Title | value) | Interfaces | Description | Interaction |
| /oic/sec/cred | Credentials | urn:oic.sec.cred | | Resource containing | Security |
| | | | | credentials for device | |
| | | | | authentication, | |
| | | | | verification and data | |
| | | | | protection | |

### Table 18 is a Device Credential Property Definition

| Property | Property | Value | Value | | Access | | | |
|---|---|---|---|---|---|---|---|---|
| Title | Name | Type | Rule | Unit | Mode | Mandatory | Instance | Description |
| Credential | CredID | UINT16 | 0 - 64K-1 | — | R | Yes | Single | Short credential ID for local |
| ID | | | | | | | | references from other resources |
| Subject | SubjectID | oic.uuid | URI | — | R | Yes | Single | Identifies the subject (e.g. |
| ID | | | | | | | | device) to which this credential |
| | | | | | | | | applies. |
| Role ID | RoleID | oic.sec.role | URI | — | R | No | Multiple | Identifies the role(s) the subject |
| | | | | | | | | is authorized to assert. |
| Credential | CredType | oic.sec.credtype | One of: | — | R | Yes | Single | 0: no security mode |
| Type | | (UINT16) | [0 \| 1 \| | | | | | 1: symmetric pair-wise key |
| | | | 2 \| 4 \| | | | | | 2: symmetric group key |
| | | | 8 \| 16] | | | | | 4: asymmetric key |
| | | | | | | | | 8: signed asymmetric key |
| | | | | | | | | (aka certificate) |
| | | | | | | | | 16: PIN/password |
| Public | PublicData | oic.sec.jwk, | — | — | R | No | Single | 1: 2: 16: friendly name |
| Data | | string OCTET[ ] | | | | | | 4: 8: Asymmetric public key or |
| | | | | | | | | certificate (if signed). JSON Web |
| | | | | | | | | Key (JWK) draft-ietf-jose-json- |
| | | | | | | | | web-key-41 or X.509 certificate |
| Private | PrivateData | oic.sec.jwk, | — | — | — | No | Single | 1: 2: secret symmetric key. |
| Data | | oic.sec.tee, | | | | | | 4: 8: Private asymmetric key. |
| | | String, | | | | | | 16: PIN/password |
| | | OCTET[ ] | | | | | | This value may not be disclosed |
| | | | | | | | | to unauthorized entities. JSON |
| | | | | | | | | Web Key (JWK) draft-ietf-jose- |
| | | | | | | | | json-web-key-41 |
| | | | | | | | | If a TEE protects the key then |
| | | | | | | | | this value may be a handle to the |
| | | | | | | | | object in the TEE. |
| Optional | Optional | OCTET[ ] | | | R | No | Single | 8: CRL |
| Data | Data | | | | | | | |
| Period | Period | String | — | — | R | No | Single | Period as defined by RFC5545. |
| | | | | | | | | The credential may not be used if |
| | | | | | | | | the current time is outside the |
| | | | | | | | | Period window. |
| Credential | Crm | oic.sec.crm.pro | — | — | R | No | Single | Credentials with a Period |
| Resource | | oic.sec.crm.dh_psk | | | | | | property are refreshed using the |
| Manager | | oic.sec.crm.dh_pin | | | | | | credential refresh method (crm) |
| | | oic.sec.crm.kdc | | | | | | according to the type definitions |
| | | | | | | | | for oic.sec.crm |
| Resource | Rowner | oic.sec.svc | oic.sec.bss, | | R | Yes | Multiple | Refers to the service resource(s) |
| owner | | | oic.sec.cps | | | | | that may instantiate/update this |
| | | | | | | | | resource. Rowner status has full |
| | | | | | | | | (C, R, U, D, N) permission. |

All secure device accesses may have an /oic/sec/cred resource authorizing the end-to-end interaction. A credential resource that does not specify PrivateData may be useful during testing and trial deployments prior to provisioning strong credentials. The ‘CredType’ value of ‘0’ (e.g. “no security mode”) is used for these scenarios.

The /oic/sec/cred resource can be created and modified by the service named in the ‘Rowner’ property. ACL resources MAY grant permission to OIC Clients other than the resource owner. The credential Rowner property allows credential provisioning to occur before ACL provisioning, which may be a necessity when establishing end-to-end secure connections that are prerequisite to ACL evaluation.

8.3 Ciphersuites for Dynamic Pair-Wise Key Generation (Normative)

In ad-hoc device interaction scenarios two devices can agree upon a pair-wise key that is used to protect subsequent interactions. The pairwise key is generated using a Diffie-Hellman ciphersuite.

The new pair-wise key updates the affected /oic/sec/cred resources for both devices. Establishing a pair-wise key is achieved using one of the following ciphersuites.
TLS_ECDH_ANON_WITH_AES_128_CBC_SHA, (* 16 octet integrity check *)
TLS_ECDH_ANON_WITH_AES_256_CBC_SHA,
TLS_ECDH_ANON_WITH_AES_128_CBC_SHA256,
TLS_ECDH_ANON_WITH_AES_256_CBC_SHA256,
TLS_ECDHE_PSK_WITH_AES_128_CBC_SHA, (* 16 octet integrity check *)
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_128_CCM_8, (* 8 octet integrity check *)
TLS_PSK_DHE_WITH_AES_256_CCM_8,
TLS_DHE_PSK_WITH_AES_128_CCM,
TLS_DHE_PSK_WITH_AES_256_CCM,

See RFC4279, RFC5489 and RFC6655.

All OIC devices may implement:
TLS_ECDH_ANON_WITH_AES_128_CBC_SHA,
TLS_ECDHE_PSK_WITH_AES_128_CBC_SHA,
TLS_PSK_DHE_WITH_AES_128_CCM_8,

Class-2 and lower devices may implement:
TLS_ECDH_ANON_WITH_AES_128_CBC_SHA256,
TLS_ECDH_ANON_WITH_AES_256_CBC_SHA,
TLS_ECDH_ANON_WITH_AES_256_CBC_SHA256,
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_256_CCM_8,
TLS_DHE_PSK_WITH_AES_128_CCM,
TLS_DHE_PSK_WITH_AES_256_CCM,

Devices above Class-2 may implement:
TLS_ECDH_ANON_WITH_AES_128_CBC_SHA256,
TLS_ECDH_ANON_WITH_AES_256_CBC_SHA,TLS_ECDH_ANON_WITH_AES_256_CBC_SHA256,
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_256_CCM_8,
TLS_DHE_PSK_WITH_AES_128_CCM,
TLS_DHE_PSK_WITH_AES 256_CCM,

Ciphersuites that accept a PSK may use a previously generated PSK when generating the new PSK.

The DTLS MasterSecret resulting from the TLS handshake exchange is input into a pseudo-random function (PRF) as follows:
PSK=TLS_PRF(MasterSecret, Message(DeviceID_A∥DeviceID_B∥“pair-wise-PSK”), length);
MasterSecret—is the MasterSecret value resulting from the DTLS handshake using one of the above ciphersuites.
Message is the concatenation of the following values:
DeviceID_A is the string representation of the device that supplied the DTLS ClientHello message where DeviceID=“urn:uuid:XXXX-XXXX-XXXX-XXXX”.
DeviceID_B is the device responding to the DTLS ClientHello message “pair-wise-PSK”—a string indicating intended use of the PSK.
Length of Message in bytes.

The PSK is derived by both device endpoints. The /oic/sec/cred resources that apply to the device pairing are updated by the local device.

8.3.1 Credential Refresh

Credential refresh methods specify the options by which a device may refresh an expired credential. The Period property may be used to expire a credential. If a credential refresh method is specified, the device may proactively obtain a new credential before the credential expires. In some cases the current credential may be used to obtain the new credential. All devices may support oic.sec.crm.pro. All devices may support oic.sec.crm.dh_pin and oic.sec.crm.dh_psk. All devices may support oic.sec.crm.kdc and oic.sec.crm.cms as appropriate.

### Table 19 Shows Credential Refresh Methods

| | Applies to these | |
|---|---|---|
| CRM Type | CredTypes | Description |
| oic.sec.crm.pro | [1\|2\|4\|8\|16] | The credential is refreshed using a credential |
| | | provisioning service. |
| oic.sec.crm.dh_psk | [1] | The credential is refreshed using the existing credential |
| | | with Diffie-Hellman key agreement to generate a new |
| | | credential. The PSK is used with DH to establish a new |
| | | session key using key derivation function (KDF). |
| oic.sec.crm.dh_pin | [16] | The credential is refreshed using the existing credential |
| | | with Diffie-Hellman key agreement to generate a new |
| | | credential. The PIN is used to generate a PSK that is |
| | | supplied to DH. The resulting session key is used to |
| | | derive a new PIN. |
| oic.sec.crm.kdc | [1\|2] | The credential is refreshed using a key distribution |
| | | center service |
| oic.sec.cms.cms | [8] | The credential is refreshed using a certificate |
| | | management service |

8.3.1.1 Oic.sec.crm.dh_psk Mode

Using this mode, the current PSK is used to establish a Diffie-Hellmen session key in DTLS. The TLS_PRF is used as the key derivation function (KDF) that produces the new (refreshed) PSK.
PSK=TLS_PRF(MasterSecret, Message(DeviceID_A∥DeviceID_B∥“pair-wise-PSK”), length);
MasterSecret—is the MasterSecret value resulting from the DTLS handshake using one of the above ciphersuites.

Message is the concatenation of the following values:
Refresh method—I.e. “oic.sec.crm.dh_psk”

DeviceID_A is the string representation of the device that supplied the DTLS ClientHello message where DeviceID=“urn:uuid:XXXX-XXXX-XXXX-XXXX”.
DeviceID_B is the device responding to the DTLS ClientHello message
“pair-wise-PSK”—a string indicating intended use of the PSK.
Length of Message in bytes.

8.3.1.2 Oic.sec.crm.dh_pin Mode

Using this mode, the current unexpired PIN is used to generate a PSK following RFC2898. The PSK is used during the Diffie-Hellman exchange to produce a new session key. The session key my be used to switch from PIN to PSK mode. Normally, the PSK is used to derive a PIN value.

The pseudo-random function (PBKDF2) defined by RFC2898. PIN is a shared value used to generate a pre-shared key. The PIN-authenticated pre-shared key (PPSK) is supplied to a TLS ciphersuite that accepts a PSK.
PPSK=PBKDF2(PRF, PIN, DeviceID, c, dkLen)

The PBKDF2 function has the following parameters:
PRF—Uses the DTLS PRF.
PIN—Shared between devices.
Refresh method—I.e. “oic.sec.crm.dh_pin”
DeviceID—UUID of the new device.
c—Iteration count initialized to 1000, incremented upon each use.
dkLen—Desired length of the derived PSK in octets.

The PIN is computed by inputting the PPSK to the PRF and specifying dkLen which is the desired length of the PIN in octets. The resultant octets may be base64 encoded to produce a human readable PIN value.

9 Simple Access Control

9.1 Overview (Informative)

Access Control in the OIC stack is expected to be transport agnostic, meaning security properties implemented by the transport may not be expected to be applied consistently across an OIC system of devices. Rather, the OIC resource model implements security resources that apply security consistently. The following section defines the OIC inter-device access control mechanisms.

An access control policy is associated with OIC server resources. Access control policy may be expressed as local ACL or an Access Manager service.

OIC access control model requires every resource instance to have an associated access control policy. OIC ACLs identify associated resources. Nested resources, such as collections, can share a common ACL policy. If a nested resource is implicated by another ACL policy, the policy that precisely identifies the resource applies. No other policy is applied—through inference inheritance.

OIC Access Control List (ACL) BNF defines ACL structures. A local ACL is composed of one or more Access Control Entries (ACE). Each ACE defines the permissions of a subject along with optionally a validity period constraint. A subject-based ACE (SBACE) will match a subject requesting access with the intended resource. A role-based ACE (RBACE) will match a role the subject possesses.

ACL structure in Backus-Naur Form (BNF) notation is shown in FIG. P:

Access control lists for unknown or anonymous (unauthenticated) subjects over the insecure port is also possible and allows for a server to define default permissions for those subjects (e.g. read-only access to a specific resource instance).

Example ACL: uuid:0000-0000-0000-0000->“/oic/*” ? 0x01 (read-only)

Every device has at least one access control resource; otherwise the device is determined to need ACL provisioning. See sections on provisioning. Access to device resources will be denied until properly provisioned ACL(s) exist.

9.2 ACL Architecture (Informative)

An OIC Client device requests access to resources from an OIC Server. The OIC Server enforces access to its resources. Access requests may be authorized based on group or device credentials. The ACL architecture illustrates four client devices seeking access to server resources. A server evaluates each request using local ACL policies and access manager services.

Figure Q is a use case-1 showing simple ACL enforcement.

Use Case 1: In the first instance, device D1 receives access to resource R1 with permission Perm0 because the local ACL /oic/sec/acl/0 matches the request.

Figure R is a use case-2 showing ACL blocking resource access.

Use Case 2: In the second instance, device D2 access is denied because no local ACL match is found and no access manager policy is found.

Figure S is a use case-3 showing Access Manager Service supported ACL.

Use Case 3: In the third instance, device D3 receives access to resource R3 with permission Perm1 because the /oic/sec/amacl/0 matches a policy to consult the AMS1 service which returns Perm1.

Figure T is a use case-4 showing dynamically obtained ACL from an AMS.

Use Case 4: In the fourth instance, device D4 receives access to resource R4 with permission Perm2 because the server fails to find a matching ACL entry and returns an error identifying AM1 as an access sacl issuer. Device D4 obtains Sacl1 signed by AMS1, which it forwards to server D5. D5 verifies the sacl signature evaluates the ACL policy that grants Perm2 access.

9.3 Local Vs. Centralized ACL Processing (Informative)

OIC servers may host ACL resources locally. Local ACLs allow greater autonomy in access control processing than remote ACL processing. Access manager services improve ACL policy management. However, it becomes a central point of failure. Due to network latency overhead, ACL processing may be slower.

9.4 Local ACL Resource (Normative)

Local hosting of remote ACLs may specify an ACL policy covering every resource hosted by the OIC Server.

TABLE 20
Local ACL resource definition

| Resource Name | Resource ID | Instances | Mandatory | Type URN |
|---|---|---|---|---|
| aci | /oic/sec/acl | Multiple | No | urn:oic.sec.acl |

TABLE 21
Local ACL Property definition

| | Property | | | | | | |
|---|---|---|---|---|---|---|---|
| Row # | Name | Opr | Instances | Mandatory | Type | Range | Description |
| Informative | normative | normative | normative | normative | normative | normative | normative |
| 0 | Subject | R | Single | Yes | String | — | URN identifying the subjects |
| | | | | | | | {Subject} or {Role} who may |
| | | | | | | | access {Resource}. |
| 1 | Resource(s) | R | Multiple | Yes | String | Fully | URN identifying the resources |
| | | | | | | qualified | that have {Permission} rights. |
| | | | | | | URI - | NULL matches no resource. |
| | | | | | | local URI | Resource path ending in |
| | | | | | | | “<path>/*” ‘asterisk’ is a wild card |
| | | | | | | | that matching all resource |
| | | | | | | | instasices at location <path>. |
| 2 | Permission | R | Single | Yes | UINT16 | 0-65535 | Access policy in least significant |
| | | | | | | | bits. |
| | | | | | | | 1st lsb: C(Create), |
| | | | | | | | 2nd lsb: R(Read, Observe, |
| | | | | | | | Discover), |
| | | | | | | | 3rd lsb: U(Write, Update) |
| | | | | | | | 4th lsb: D(Delete) |
| | | | | | | | 5th lsb: N (Notify) |
| 3 | Period | R | Multiple* | No | String | — | Period as defined by RFC5545 |
| | | | | | | | *Multiple Period/Recurrence tuple |
| | | | | | | | sets. |
| 4 | Recurrence | R | Multiple | No | String | — | Recurrence rule as defined by |
| | | | | | | | RFC5545 |
| 5 | Rowner(s) | R | Multiple | Yes | oic.sec.svc | oic.sec.bss, | Provisioning service authorized to |
| | | | | | | oic.sec.aps | read, create, update and delete |
| | | | | | | | this object. |

Local ACL resources supply policy to a resource access enforcement point within an OIC stack instance. The OIC framework gates OIC client access to OIC server resources. It evaluates the subject's request using policy in the ACL.

Resources named in the ACL policy may be fully qualified or partially qualified. Fully qualified resource references may include the device identifier of a remote device hosting the resources. Partially qualified references imply the local resource server is hosting the resource. If a fully qualified resource reference is given, the intermediary enforcing access may have a secure channel to the resource server and the resource server may verify the intermediary is authorized to act on its behalf as a resource access enforcement point.

Resource servers may include references to device and ACL resources where access enforcement is to be applied. However, access enforcement logic may not depend on these references for access control processing as access to server resources will have already been granted.

Local ACL resources identify a Rowner service that is authorized to instantiate and modify this resource. This prevents non-terminating dependency on some other ACL resource. Nevertheless, it may be desirable to grant access rights to ACL resources using an ACL resource.

9.5 Access Managers (Normative)

Access manager services centralizing access control decisions, but OIC server devices retain enforcement duties. The server may determine which ACL mechanism to use for which resource set. The /oic/sec/amacl resource is an ACL structure that specifies which resources will use an access manager service to resolve access decisions. The aclam may be used in concert with local ACLs (/oic/sec/acl).

The provisioning services resource (/oic/sec/svc) may contain an Access Manager service entry of type oic.sec.ams.

The OIC server device may open a connection to a service of type oic.sec.ams. Alternatively, the OIC server may reject the resource access request with an error that instructs the requestor to obtain a suitable access sacl. The sacl signature may be validated using the credential resource associated with a service of type oic.sec.ams.

9.5.1 Access Manager ACL Resource

Access manager ACL resource definition:

TABLE 22
Access manager ACL resource definition

| Resource | | | | |
|---|---|---|---|---|
| Name | Resource ID | Instances | Mandatory | Type URN |
| amacl | /oic/sec/amacl | Multiple | No | urn:oic.sec.amacl |

TABLE 23
Access manager ACL Property definition

| | Property | | | | | | |
|---|---|---|---|---|---|---|---|
| Row # | Name | Opr | Instances | Mandatory | Type | Range | Description |
| 0 | Resource(s) | R | Multiple* | Yes | String | — | URN identifying the resource |
| | | | | | | | instance to be accessed. |
| | | | | | | | (E.g./oic/d). |
| 1 | Ams(s) | R | Multiple* | Yes | oic.sec.svc | oic.sec.ams | The AM service that may issue |
| | | | | | | | an access sacl on behalf of the |
| | | | | | | | requester. *Multiple AMs are |
| | | | | | | | backups in case the primary |
| | | | | | | | AM is not available. |
| 2 | Rowner(s) | R | Multiple | Yes | oic.sec.svc | oic.sec.bss, | Provisioning service authorized |
| | | | | | | oic.sec.aps | to modify this object. |

9.5.2 Signed ACL Resource

TABLE 24
Signed ACL resource definition

| Resource Name | Resource ID | Instances | Mandatory | Type URN |
|---|---|---|---|---|
| sacl | /oic/sec/sacl | Multiple | No | urn:oic.sec.sacl |

TABLE 25
Signed ACL Property definition

| | Property | | | | | | |
|---|---|---|---|---|---|---|---|
| Row # | Name | Operations | Instances | Mandatory | Type | Range | Description |
| 0 | Acl | R | Multiple* | Yes | oic.sec.acl | — | A local ACL resource |
| | | | | | | | containing an access policy |
| | | | | | | | specific to the subject's |
| | | | | | | | resource request. |
| 1 | Ams | R | Single | Yes | oic.sec.svc | oic.sec.ams | The access sacl issuer |
| | | | | | | | 2service. |
| 2 | Signature | R | Single | Yes | oic.sec.pk9 | | Signature bits over the sacl. |
| | | | | | oic.sec.jws | | The signature structure |
| | | | | | | | defines the signature format. |
| | | | | | | | (e.g. JWS (draft-ietf-jose-json- |
| | | | | | | | web-signature-41), PKCS#9 |
| | | | | | | | (RFC2985) etc . . . ) |

9.6 ACL Evaluation (Normative)

Security may be compromised if access rules are misapplied. The OIC server may enforce access control policy before exposing resources to the requestor. The security manager in the OIC server authenticates the requestor if access is received via the secure port (See Section 8). If the request arrives over the unsecured port, the only ACL policies allowed are for anonymous requestors (See Section 9.1). If the anonymous ACL policy doesn't name the requested resource access is denied.

A wild card resource identifier may be used to apply a blanket policy for a collection of resources. For example, /a/light/* matches all instances of the light resource.

Evaluation of local ACL resources completes when all ACL resources have been queried and no entry can be found for the requested resource for the requestor—e.g. /oic/sec/acl /oic/sec/sacl and /oic/sec/amacl do not match the subject and the requested resource.

If an access manager ACL satisfies the request, the OIC server opens a secure connection to the Access Manager Service (AMS). If the primary AMS is unavailable, a secondary AMS may be tried. The OIC server queries the AMS supplying the subject and requested resource as filter criteria. The OIC server device ID is taken from the secure connection context and included as filter criteria by the AMS. If the AMS policy satisfies the Permission property (See 9.5.1) is returned.

If the requested resource is still not matched, the OIC server returns an error. The requester may query the OIC server to discover the configured AMS services. The OIC client may contact the AMS to request an access sacl (/oic/sec/sacl) resource. Performing the following operations makes the request:
1) OIC client: Open secure connection to AMS.
2) OIC client: GET /oic/sec/acl?device=“urn:uuid:XXX . . . ”,resource=“URI”
3) AMS: constructs a /oic/sec/sacl resource that is signed by the AMS and returns it in response to the GET command.
4) OIC client: POST /oic/sec/sacl [{ . . . sacl . . . }]
5) OIC server: verifies sacl signature using AMS credentials and installs the ACL resource if valid.
6) OIC client: retries original resource access request. This time the new ACL is included in the local acl evaluation.

The ACL contained in the /oic/sec/sacl resource may grant longer term access that satisfies repeated resource requests.

10 Device Security Considerations

10.1 DTLS Counter Measures (Normative)

When DTLS is used for message confidentiality and/or integrity protection between OIC devices the following conditional requirements are specified:
The DTLS implementation is required to implement counter measures for client hello flooding attacks using the DTLS defined cookie mechanism.
The DTLS implementation is required to implement counter measures for replay attacks via the sequence number in the header.
DTLS sessions that are attempted with same epoch for an already existing endpoint may allow for the handshake to complete then invalidate the previous session that was associated with the specific epoch.

The following example access control scenarios use synthetic data illustration purposes.

11.1 Example OIC ACL Resource:

The second local ACL (e.g. /oic/sec/acl/1)

TABLE 26
Example acl resource

| | | Property | | |
|---|---|---|---|---|
| Property | Property | Instance | | |
| Name | ID | ID | Value | Notes |
| Subject | 0 | 0 | Uuid: XXXX-..-XX01 | Subject with ID . . . 01 may access resources {1, 0} and |
| | | | | {1, 1} with permission {2} |
| Resource | 1 | 0 | {Device1}/oic/sh/light/* | If resource {light, ANY} @ host1 was requested, by |
| | | | | subject {0, 0}, {0, 1} or {0, 2} then grant access with |
| | | | | permission 0h001F. |
| Resource | 1 | 1 | {Device2}/oic/sh/temp/0 | If resource {temp, 0} @ host2 was requested, by |
| | | | | subject {0, 0}, {0, 1} or {0, 2} then grant access with |
| | | | | permission 0h001F. |
| Permission | 2 | — | 0h001F | C, R, U, D, N permission is granted |
| Period | 3 | 0 | 20150101T180000Z/20150102T070000Z | The period starting at 18:00:00 UTC, on Jan. 1, |
| | | | | 2015 and ending at 07:00:00 UTC on Jan. 2, 2015 |
| Recurrence | 4 | 0 | RRULE:FREQ=WEEKLY; | Repeats the {period} every week until the last day of |
| | | | UNTIL=20150131T070000Z | January 2015. |
| Rowner | 5 | 0 | oic.sec.svc?rt=“oic.sec.aps” | Only the ACL provisioning service listed in the |
| | | | | provisioning services resource with type “oic:sec:aps” |
| | | | | may update this resource. |

11.2 Example Access Manager Service:

Access Manager Service Resource (e.g. /oic/sec/amacl/0)

TABLE 27
Example access manager resource

| | Property | Property | | |
|---|---|---|---|---|
| Property Name | ID | Instance ID | Value | Notes |
| Resource | 0 | 0 | {Device1}/oic/sh/light/* | If the (Subject) wants to access the |
| | | | | /oic/sh/light/* resources at host1 and an |
| | | | | AM sacl was supplied then use the {1} sacl |
| | | | | validation credential to enforce access. |
| Resouce | 0 | 1 | {Device2}/oma/3 | If the {Subject} wants to acess the /oma/3 |
| | | | | resource at host2 and an AM sacl was |
| | | | | supplied then use the {1} sacl validation |
| | | | | credential to enforce access. |
| Resource | 0 | 2 | /* | If the {Subject} wants to access any local |
| | | | | resource and an AM sacl was supplied |
| | | | | then use the {1} sacl validation credential |
| | | | | to enforce access. |
| OIC Access | 1 | 0 | href://<address>/oic/sec/am/0 | Forwarding reference for where requestor |
| manager | | | | may obtain a signed ACL. |
| OIC Access | 1 | 1 | href://<address>/oic/sec/am/1 | Secondary forwarding reference for where |
| manager | | | | requestor may obtain a signed ACL. |
| Rowner | 2 | 0 | oic.sec.svc?rt=“oic.sec.aps” | Only the ACL provisioning service listed in |
| | | | | the provisioning services resource with |
| | | | | type “oic:sec:aps” may update this |
| | | | | resource. |

1-20. (canceled)

21: At least one computer readable storage medium comprising instructions that when executed enable a system to:
responsive to a first request from a first client device to access a first resource of the system, grant access to the first resource based on a first access control entry in a first access control list of the system, the first access control entry to identify the first client device as a subject, to identify the first resource, and to identify a permission type associated with the first resource and the first client device, wherein the system comprises a server device;
responsive to a second request from a second client device to access a second resource of the system, deny access to the second resource responsive to absence of an access control policy in the system for the second client device pertaining to the second resource;
responsive to a third request from a third client device to access a third resource of the system, send information corresponding to the third request to an access manager service of an access manager server,
wherein a second access control entry of a second access control list of the system is to indicate that the system is to consult the access manager service of the access manager server, the second access control entry to identify the third client device as a subject, to identify the third resource, and to identify the access manager service; and
grant the third client device access to the third resource in response to a reply from the access manager service.

22: The at least one computer readable storage medium of claim 21, wherein the first client device has a first relevance value and the second client device has a second relevance value.

23: The at least one computer readable storage medium of claim 22, further comprising instructions that when executed enable the system to store the first access control list in the system based on the first relevance value and not store the access control policy in the system based on the second relevance value.

24: The at least one computer readable storage medium of claim 21, wherein the reply from the access manager service includes an access grant from the access manager service and based thereon the system is to grant the third client device access to the third resource.

25: The at least one computer readable storage medium of claim 21, further comprising instructions that when executed enable the system to:
responsive to a fourth request from a fourth client device to access a fourth resource of the system, wherein at a time of receipt of the fourth request, the system does not store a third access control policy for the fourth client device pertaining to the fourth resource; and
send a redirection message to the fourth client device, to cause the fourth client device to send a request to the access manager service.

26: The at least one computer readable storage medium of claim 25, further comprising instructions that when executed enable the system to receive a third access control entry from the fourth client device, the third access control entry obtained in the fourth client device from the access manager service, and store the third access control entry in the system.

27: The at least one computer readable storage medium of claim 26, further comprising instructions that when executed enable the system to, responsive to another request from the fourth client device, grant access to the fourth resource based on the third access control entry, the third access control entry to identify the fourth client device as a subject, to identify the fourth resource, and to identify a permission type associated with the fourth resource and the fourth client device.

28: The at least one computer readable storage medium of claim 21, wherein the first access control list comprises a signed access control list, and further comprising instructions that when executed enable the system to, responsive to another request from another client device to access the first resource, deny access to the first resource if a signature of the signed access control list is invalid.

29: The at least one computer readable storage medium of claim 21, further comprising instructions that when executed enable the system to grant access to the first resource based at least in part on identity of the first computing device.

30: The at least one computer readable storage medium of claim 21, further comprising instructions that when executed enable the system to grant access to the first resource based at least in part on a role of the first computing device.

31: The at least one computer readable storage medium of claim 21, further comprising instructions that when executed enable the system to grant access to the first resource based at least in part on a group credential to indicate membership of the first computing device in a group of devices.

32: A method comprising:
responsive to a first request from a first client device to access a first resource of a system, granting access to the first resource based on a first access control entry in a first access control list of the system, the first access control entry to identify the first client device as a subject, to identify the first resource, and to identify a permission type associated with the first resource and the first client device;
responsive to a second request from a second client device to access a second resource of the system, denying access to the second resource responsive to absence of an access control policy in the system for the second client device pertaining to the second resource;
responsive to a third request from a third client device to access a third resource of the system, sending information corresponding to the third request to an access manager service of an access manager server, wherein a second access control entry of a second access control list of the system is to indicate that the system is to consult the access manager service of the access manager server, the second access control entry to identify the third client device as a subject, to identify the third resource, and to identify the access manager service; and
granting the third client device access to the third resource in response to a reply from the access manager service.

33: The method of claim 32, further comprising responsive to a fourth request from a fourth client device to access a fourth resource of the system, wherein at a time of receipt of the fourth request, the system does not store a third access control policy for the fourth client device pertaining to the fourth resource, sending a redirection message to the fourth client device, to cause the fourth client device to send a request to the access manager service.

34: The method of claim 33, further comprising:
receiving a third access control entry from the fourth client device, the third access control entry obtained in the fourth client device from the access manager service; and
storing the third access control entry in the system.

35: The method of claim 34, further comprising granting access to the fourth resource based on the third access control entry, the third access control entry to identify the fourth client device as a subject, identify the fourth resource, and identify a permission type associated with the fourth resource and the fourth client device.

36: The method of claim 32, further comprising granting access to the first resource based at least in part on a group credential to indicate membership of the first computing device in a group of devices.

37: A system comprising:
a processor;
a first storage to store a plurality of access control lists; and
a second storage to store instructions that when executed enable the system to:
responsive to a first request from a first client device to access a first resource of the system, grant access to the first resource based on a first access control entry in a first access control list, the first access control entry to identify the first client device as a subject, to identify the first resource, and to identify a permission type associated with the first resource and the first client device;
responsive to a second request from a second client device to access a second resource of the system, deny access to the second resource responsive to absence of an access control policy for the second client device pertaining to the second resource;
responsive to a third request from a third client device to access a third resource of the system, send information corresponding to the third request to an access manager service of an access manager server, wherein a second access control entry of a second access control list of the system is to indicate that the system is to consult the access manager service of the access manager server, the second access control entry to identify the third client device as a subject, to identify the third resource, and to identify the access manager service; and
grant the third client device access to the third resource in response to a reply from the access manager service.

38: The system of claim 37, wherein the system is to dynamically provision the first access control list to the first computing device.

39: The system of claim 38, wherein the system is to dynamically provision the first access control list to the first computing device for a temporary duration.

40: The system of claim 37, wherein the second storage further comprises instructions that, when the first access control list comprises a signed access list, enable the system to, responsive to another request from another client device to access the first resource, deny access to the first resource if a signature of the signed access control list is invalid.
